(19) United States
(12) Patent Application Publication
(10) Pub. No.: US 2024/0019692 A1
(43) Pub. Date: Jan. 18, 2024

(54) OPTICAL SYSTEM

(71) Applicant: SIGMA CORPORATION, Kanagawa (JP)

(72) Inventor: Ryo SHIOTA, Kanagawa (JP)

(21) Appl. No.: 18/103,174

(22) Filed: Jan. 30, 2023

(30) Foreign Application Priority Data
Jul. 15, 2022 (JP) 2022-113938

(51) Int. Cl. G02B 27/00; G02B 13/18; G02B 13/00

(52) U.S. Cl. CPC G02B 27/0062; G02B 13/18; G02B 13/0045

(57) ABSTRACT

To provide an optical system that achieves a reduction in weight while correcting various aberrations, such as chromatic aberration, with appropriate use of a glass material for lenses forming respective lens groups. Provided is an optical system characterized in that an object-side lens group GF and an image-side lens group GR are arranged in order from an object side, and the optical system includes a lens LA that satisfies a predetermined conditional expression.

### BACKGROUND OF THE INVENTION

### Field of the Invention

The present invention relates to an optical system suitable for a lens used for an image pickup device, such as a still camera or a video camera, or for a projection device, and relates to an optical system that can effectively correct chromatic aberration.

### Description of the Related Art

Recently, along with an increase in the number of pixels of digital cameras or the like, there has been a demand for an optical system used in image pickup devices, projection devices, or the like, to strictly correct various aberrations.

For this reason, an optical system has been proposed where an extra-low dispersion glass is used to correct chromatic aberration for a wavelength range from the C line to the g line.

However, the above-mentioned related arts have the following problems.

Japanese Patent Laid-Open No. 2020-101750 (Patent Literature 1) discloses a variable power optical system that uses an extra-low dispersion glass, corresponding to FCD1 manufactured by HOYA CORPORATION, to achieve a wide angle of view and suppression of axial chromatic aberration at the wide angle end. However, the optical system described in Patent Literature 1 has the problem that magnification chromatic aberration of is not sufficiently corrected especially at the wide angle end.

International Publication No. WO 2019-07344 (Patent Literature 2) discloses an optical system that can suppress axial chromatic aberration while having a wide angle of view. However, the optical system described in Patent Literature 2 has the problem that color flare is liable to remain within the range from an intermediate angle of view to the periphery of a screen due to the deviation of image forming points from the C line to the F line in the direction of the optical axis.

Japanese Patent Laid-Open No. 2019-152887 (Patent Literature 3) discloses an optical system that uses an extra-low dispersion glass, corresponding to calcium fluoride, to suppress axial chromatic aberration. However, the optical system described in Patent Literature 3 has the problem that magnification chromatic aberration from the g line to the h line is not sufficiently corrected.

Japanese Patent Laid-Open No. 2019-020450 (Patent Literature 4) discloses a variable power optical system that uses an extra-low dispersion glass, corresponding to FCD1 manufactured by HOYA CORPORATION, to suppress axial chromatic aberration at the telephoto end. However, the variable power optical system described in Patent Literature 4 has the problem that axial chromatic aberration is not sufficiently corrected at the wide angle end and magnification chromatic aberration is not sufficiently corrected at the telephoto end.

An object of the present invention, which has been made in view of at least one of such problems, is to provide an optical system that achieves correction of various aberrations, such as chromatic aberration with appropriate use of a lens material.

### SUMMARY OF THE INVENTION

To achieve the above-mentioned object, in an optical system according to the present invention, an object-side lens group GF and an image-side lens group GR are arranged in order from an object side, the object-side lens group GF has negative refractive power as a whole, and the image-side lens group GR has positive refractive power as a whole, and at least either one of the object-side lens group GF or the image-side lens group GR includes a lens LA that satisfies a following conditional expression (1):

VD_A>96.00 (1)

where
VD_A: an Abbe number of the lens LA based on a d line.

The optical system according to the present invention is preferably characterized in that the lens LA satisfies a following conditional expression (2):

ΔθgF_A>0.057 (2)

where

ΔθgF_A: a mean value of a deviation ΔθgF of a partial dispersion ratio of the lens LA with respect to a g line, wherein the deviation ΔθgF of the partial dispersion ratio with respect to the g line is calculated for each lens by

ΔθgF=θgF−(0.648285−0.00180123×VD)
in a case where the partial dispersion ratio with respect to the g line is taken as θgF, and an Abbe number for the d line is taken as VD.

The optical system according to the present invention is preferably characterized in that in a case where power of the optical system varies, at least a spacing between the object-side lens group GF and the image-side lens group GR changes when the power varies, and
the lens LA is disposed in the object-side lens group GF and has negative refractive power.

The optical system according to the present invention is preferably characterized in that in a case where power of the optical system varies, at least a spacing between the object-side lens group GF and the image-side lens group GR changes when the power varies, and
the lens LA is disposed in the image-side lens group GR and has positive refractive power.

The optical system according to the present invention is preferably characterized in that with focus being at infinity in a maximum wide angle state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR, and
the lens LA is disposed in the object-side lens group GF and has negative refractive power.

The optical system according to the present invention is preferably characterized in that with focus being at infinity in a maximum wide angle state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR, and
the lens LA is disposed in the image-side lens group GR and has positive refractive power.

The optical system according to the present invention is preferably characterized in that the optical system includes a lens group GFA that includes the lens LA and that has negative refractive power,
in a case where power of the optical system varies, in dividing the object-side lens group GF into lens groups by using, as boundaries, all air spacings that change when the power varies, the lens group GFA is disposed at a position closest to an image-side in the object-side lens group GF, or the lens group GFA is identical with the object-side lens group GF,
in a case where no power of the optical system varies, the lens group GFA is identical with the object-side lens group GF, and
the lens group GFA includes four or more lenses.

The optical system according to the present invention is preferably characterized in that the object-side lens group GF has an aspherical surface where positive refractive power increases or negative refractive power decreases with respect to a center of an optical axis in an area around an effective light diameter.

The optical system according to the present invention is preferably characterized in that the image-side lens group GR has an aspherical surface where positive refractive power decreases or negative refractive power increases with respect to a center of an optical axis in an area around an effective light diameter.

To achieve the above-mentioned object, in an optical system according to the present invention, an object-side lens group GF and an image-side lens group GR are arranged in order from an object side, an aperture stop is disposed between the object-side lens group GF and the image-side lens group GR, the object-side lens group GF has positive refractive power or negative refractive power as a whole, and the image-side lens group GR has positive refractive power as a whole, and at least either one of the object-side lens group GF or the image-side lens group GR includes a lens LA that satisfies a following conditional expression (1):

VD_A>96.00 (1)

where
VD_A: an Abbe number of the lens LA based on a d line.

The optical system according to the present invention is preferably characterized in that the lens LA satisfies a following conditional expression (2):

ΔθgF_A>0.057 (2)

where
ΔθgF_A: a mean value of a deviation ΔθgF of a partial dispersion ratio of the lens LA with respect to a g line,
   wherein the deviation ΔθgF of the partial dispersion ratio with respect to the g line is calculated for each lens by

ΔθgF=θgF−(0.648285−0.00180123×VD)
in a case where the partial dispersion ratio with respect to the g line is taken as θgF, and an Abbe number for the d line is taken as VD.

The optical system according to the present invention is preferably characterized in that in a case where power of the optical system varies, at least a spacing between the object-side lens group GF and the image-side lens group GR changes when the power varies, and
the lens LA is disposed in the object-side lens group GF and has negative refractive power.

The optical system according to the present invention is preferably characterized in that in a case where power of the optical system varies, at least a spacing between the object-side lens group GF and the image-side lens group GR changes when the power varies, and
the lens LA is disposed in the image-side lens group GR and has positive refractive power.

The optical system according to the present invention is preferably characterized in that with focus being at infinity in a maximum wide angle state in a case where power of the optical system varies, or with focus being at infinity in a case where no power of the optical system varies, a height, from an optical axis, of an axial marginal ray that passes through the aperture stop is greater than a height, from the optical axis, of an axial marginal ray that passes through an optical surface of the optical system that is disposed at a position closest to the object side.

The optical system according to the present invention is preferably characterized in that the optical system includes a lens group GFA that includes the lens LA and that has negative refractive power,
in a case where power of the optical system varies, in dividing the object-side lens group GF into lens groups by using, as boundaries, all air spacings that change when the power varies, the lens group GFA is disposed at a position closest to the object side among lens groups included by the object-side lens group GF and having negative refractive power,
in a case where no power of the optical system varies, in dividing the object-side lens group GF into lens groups by using, as boundaries, all air spacings that change when focusing is performed, the lens group GFA is disposed at a position closest to the object side among lens groups included by the object-side lens group GF and having negative refractive power, and
the lens group GFA includes four or more lenses.

The optical system according to the present invention is preferably characterized in that the object-side lens group GF has an aspherical surface where positive refractive power increases or negative refractive power decreases with respect to a center of the optical axis in an area around an effective light diameter.

The optical system according to the present invention is preferably characterized in that the image-side lens group GR has an aspherical surface where positive refractive power decreases or negative refractive power increases with respect to a center of the optical axis in an area around an effective light diameter.

To achieve the above-mentioned object, in an optical system according to the present invention, an object-side lens group GF having positive refractive power and an image-side lens group GR are arranged in order from an object side, an aperture stop is provided, and the optical system includes a lens LA that satisfies a following conditional expression (1):

VD_A>96.00 (1)

where
VD_A: an Abbe number of the lens LA based on a d line.

The optical system according to the present invention is preferably characterized in that the lens LA satisfies a following conditional expression (2):

ΔθgF_A>0.057 (2)

where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by

ΔθgF=θgF−(0.648285−0.00180123×VD)
in a case where the partial dispersion ratio with respect to the g line is taken as θgF, and an Abbe number for the d line is taken as VD.

The optical system according to the present invention is preferably characterized in that in a case where power of the optical system varies, at least a spacing between the object-side lens group GF and the image-side lens group GR changes when the power varies, the lens LA is disposed in the object-side lens group GF and has positive refractive power, and a following conditional expression (3) is satisfied:

DAF/f>0.270 (3)

where
in a case where no power of the optical system varies,
DAF: a spacing on an optical axis between an image-side surface of the lens LA disposed in the object-side lens group GF and the aperture stop with focus at infinity
f: a focal length of the optical system with focus at infinity
in the case where the power of the optical system varies,
DAF: a spacing on the optical axis between the image-side surface of the lens LA disposed in the object-side lens group GF and the aperture stop with focus at infinity in a maximum telephoto state
f: a focal length of the optical system with focus at infinity in the maximum telephoto state.

The optical system according to the present invention is preferably characterized in that in a case where power of the optical system varies, at least a spacing between the object-side lens group GF and the image-side lens group GR changes when the power varies,
the lens LA is disposed in the image-side lens group GR and has negative refractive power, and
a following conditional expression (4) is satisfied:

DAR/f>0.120 (4)

where
in a case where no power of the optical system varies,
DAR: a spacing on an optical axis between the aperture stop and an object-side surface of the lens LA disposed in the image-side lens group GR with focus at infinity
f: a focal length of the optical system with focus at infinity
in the case where the power of the optical system varies,
DAR: a spacing on the optical axis between the aperture stop and the object-side surface of the lens LA disposed in the image-side lens group GR with focus at infinity in a maximum telephoto state
f: a focal length of the optical system with focus at infinity in the maximum telephoto state.

The optical system according to the present invention is preferably characterized in that with focus being at infinity in a maximum telephoto state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR,
the lens LA is disposed in the object-side lens group GF and has positive refractive power, and
a following conditional expression (3) is satisfied:

DAF/f>0.270 (3)

where in the case where no power of the optical system varies,
DAF: a spacing on an optical axis between an image-side surface of the lens LA disposed in the object-side lens group GF and the aperture stop with focus at infinity
f: a focal length of the optical system with focus at infinity in the case where the power of the optical system varies,
DAF: a spacing on the optical axis between the image-side surface of the lens LA disposed in the object-side lens group GF and the aperture stop with focus at infinity in the maximum telephoto state
f: a focal length of the optical system with focus at infinity in the maximum telephoto state.

The optical system according to the present invention is preferably characterized in that with focus being at infinity in a maximum telephoto state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR,
the lens LA is disposed in the image-side lens group GR and has negative refractive power, and
a following conditional expression (4) is satisfied:

DAR/f>0.120 (4)

where
in the case where no power of the optical system varies,
DAR: a spacing on an optical axis between the aperture stop and an object-side surface of the lens LA disposed in the image-side lens group GR with focus at infinity
f: a focal length of the optical system with focus at infinity in the case where the power of the optical system varies,
DAR: a spacing on the optical axis between the aperture stop and the object-side surface of the lens LA disposed in the image-side lens group GR with focus at infinity in the maximum telephoto state
f: a focal length of the optical system with focus at infinity in the maximum telephoto state.

The optical system according to the present invention is preferably characterized in that a following conditional expression (5) is satisfied:

0.40>DFR/LT>0.10 (5)

where
in the case where no power of the optical system varies,
DFR: an air spacing on the optical axis between the object-side lens group GF and the image-side lens group GR with focus at infinity
LT: a spacing on the optical axis between a surface of the optical system that is disposed at a position closest to the object side and an image plane with focus at infinity
in the case where the power of the optical system varies,
DFR: an air spacing on the optical axis between the object-side lens group GF and the image-side lens group GR with focus at infinity in the maximum telephoto state
LT: a spacing on the optical axis between the surface of the optical system that is disposed at the position closest to the object side and the image plane with focus at infinity in the maximum telephoto state.

To achieve the above-mentioned object, in an optical system according to the present invention, an object-side lens group GF having positive refractive power and an image-side lens group GR are arranged in order from an object side, an aperture stop is disposed between the object-side lens group GF and the image-side lens group GR, and the optical system includes a lens LA that satisfies a following conditional expression (1):

VD_A>96.00 (1)

where
VD_A: an Abbe number of the lens LA based on a d line.

The optical system according to the present invention is preferably characterized in that the lens LA satisfies a following conditional expression (2):

ΔθgF_A>0.057 (2)

where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by

ΔθgF=θgF−(0.648285−0.00180123×VD)
in a case where the partial dispersion ratio with respect to the g line is taken as θgF, and an Abbe number for the d line is taken as VD.

The optical system according to the present invention is preferably characterized in that the lens LA is disposed in the object-side lens group GF and has positive refractive power, and
a following conditional expression (3) is satisfied:

DAF/f>0.270 (3)

where
in a case where no power of the optical system varies,
DAF: a spacing on an optical axis between an image-side surface of the lens LA disposed in the object-side lens group GF and the aperture stop with focus at infinity
f: a focal length of the optical system with focus at infinity
in a case where power of the optical system varies, DAF: a spacing on the optical axis between the image-side surface of the lens LA disposed in the object-side lens group GF and the aperture stop with focus at infinity in a maximum telephoto state
f: a focal length of the optical system with focus at infinity in the maximum telephoto state.

The optical system according to the present invention is preferably characterized in that the lens LA is disposed in the image-side lens group GR and has negative refractive power, and
a following conditional expression (4) is satisfied:

DAR/f>0.120 (4)

where
in a case where no power of the optical system varies,
DAR: a spacing on an optical axis between the aperture stop and an object-side surface of the lens LA disposed in the image-side lens group GR with focus at infinity
f: a focal length of the optical system with focus at infinity
in a case where power of the optical system varies, DAR: a spacing on the optical axis between the aperture stop and the object-side surface of the lens LA disposed in the image-side lens group GR with focus at infinity in a maximum telephoto state
f: a focal length of the optical system with focus at infinity in the maximum telephoto state.

The optical system according to the present invention is preferably characterized in that in the case where the power of the optical system varies, with focus at infinity in the maximum telephoto state, or in the case where no power of the optical system varies, with focus at infinity, a height, from the optical axis, of an axial marginal ray that passes through the aperture stop is less than a height, from the optical axis, of an axial marginal ray that passes through an optical surface of the optical system that is disposed at a position closest to the object side.

The optical system according to the present invention is preferably characterized in that a following conditional expression (6) is satisfied:

0.70>HS/HR1>0.20 (6)

where
in the case where no power of the optical system varies,
HS: the height, from the optical axis, of the axial marginal ray that passes through the aperture stop with focus at infinity
HR1: the height, from the optical axis, of the axial marginal ray that passes through the optical surface of the optical system that is disposed at the position closest to the object side with focus at infinity
in the case where the power of the optical system varies,
HS: the height, from the optical axis, of the axial marginal ray that passes through the aperture stop with focus at infinity in the maximum telephoto state
HR1: the height, from the optical axis, of the axial marginal ray that passes through the optical surface of the optical system that is disposed at the position closest to the object side with focus at infinity in the maximum telephoto state.

With the optical system according to the present invention, it is possible to provide an optical system that can achieve a reduction in weight while correcting various aberrations, such as chromatic aberration, with appropriate use of a glass material for lenses forming respective lens groups.

### BRIEF DESCRIPTION OF THE DRAWINGS

FIG. 1 is a lens configuration diagram of a variable power optical system of an example 1 with focus at infinity at a wide angle end;

FIG. 2 is a longitudinal aberration diagram of the variable power optical system of the example 1 with focus at infinity at the wide angle end;

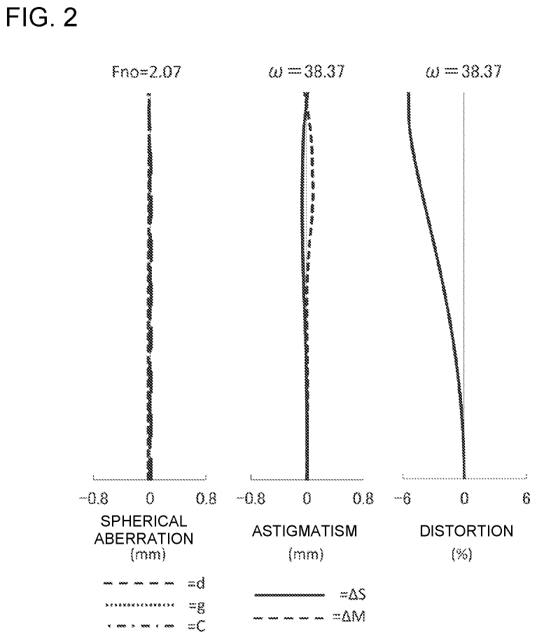

FIG. 3 is a longitudinal aberration diagram of the variable power optical system of the example 1 with focus at infinity at an intermediate focal length;

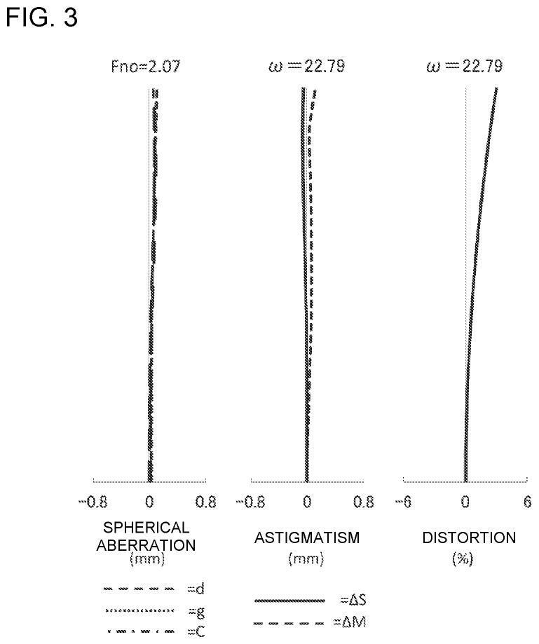

FIG. 4 is a longitudinal aberration diagram of the variable power optical system of the example 1 with focus at infinity at a telephoto end;

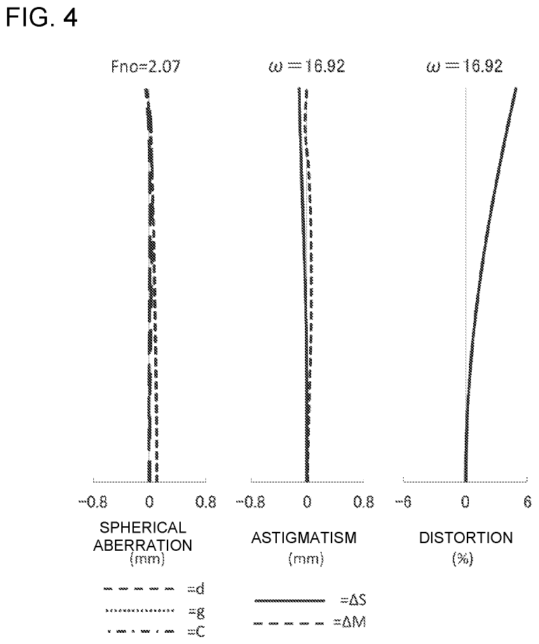

FIG. 5 is a transverse aberration diagram of the variable power optical system of the example 1 with focus at infinity at the wide angle end;

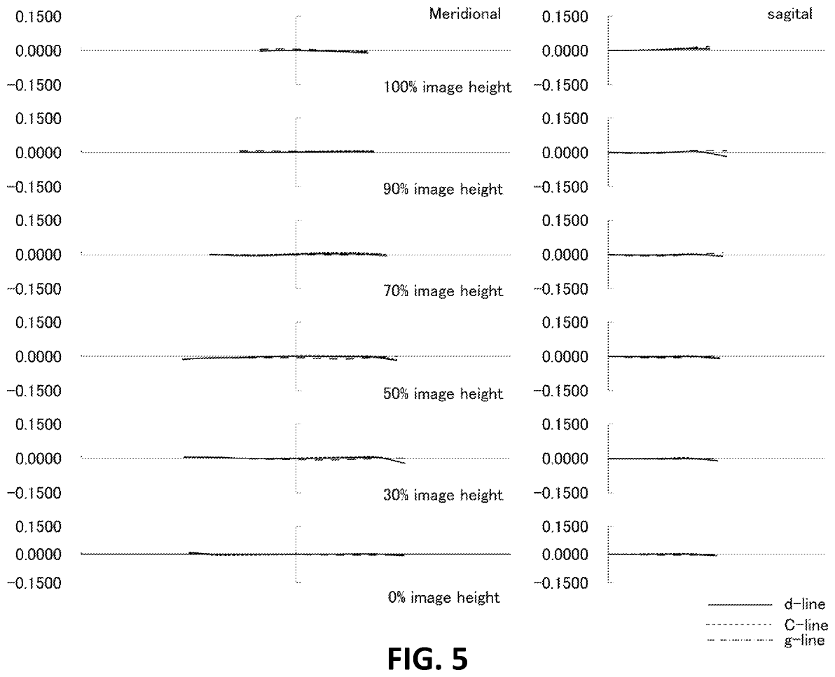

FIG. 6 is a transverse aberration diagram of the variable power optical system of the example 1 with focus at infinity at the intermediate focal length;

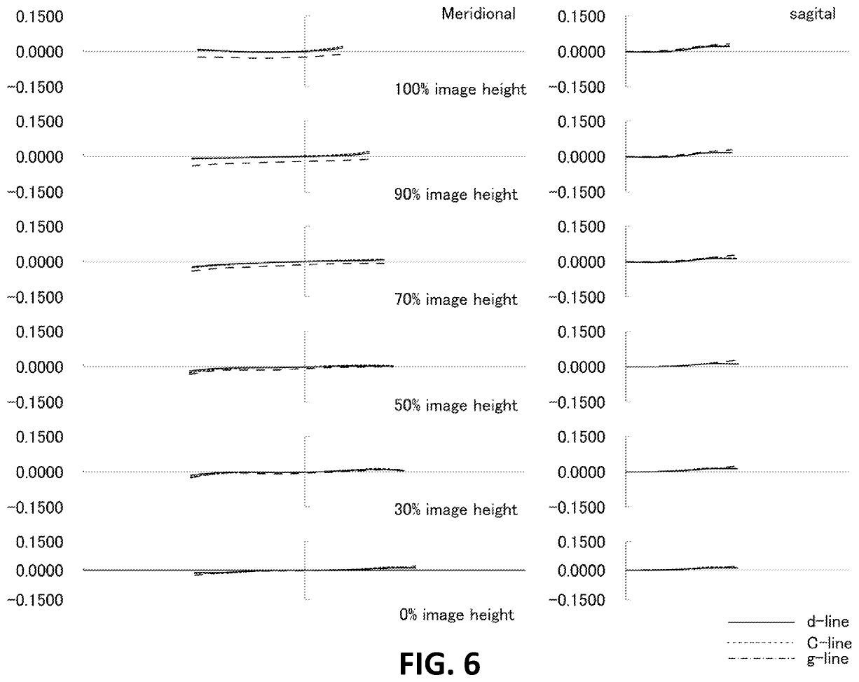

FIG. 7 is a transverse aberration diagram of the variable power optical system of the example 1 with focus at infinity at the telephoto end;

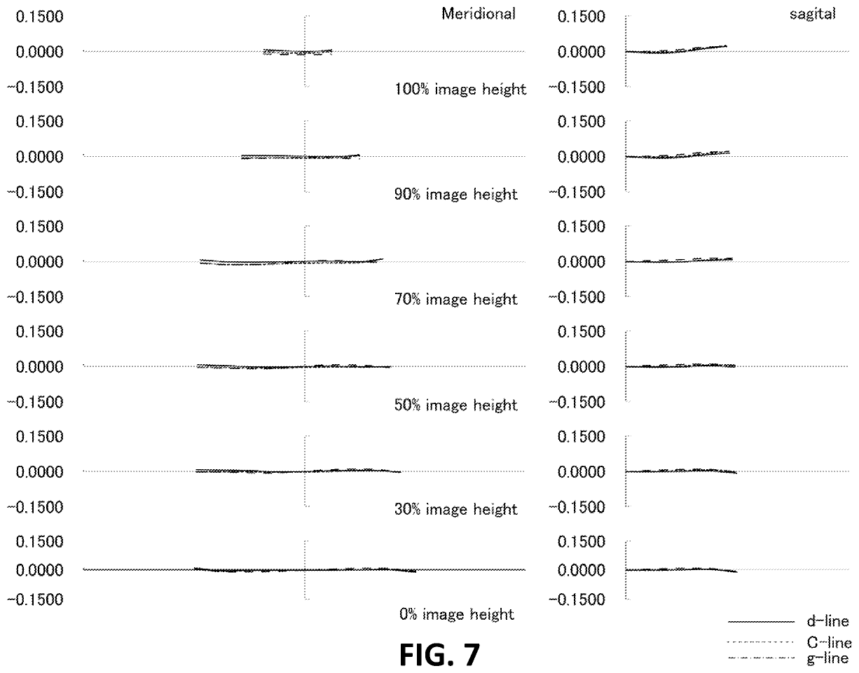

FIG. 8 is a lens configuration diagram of a variable power optical system of an example 2 with focus at infinity at a wide angle end;

FIG. 9 is a longitudinal aberration diagram of the variable power optical system of the example 2 with focus at infinity at the wide angle end;

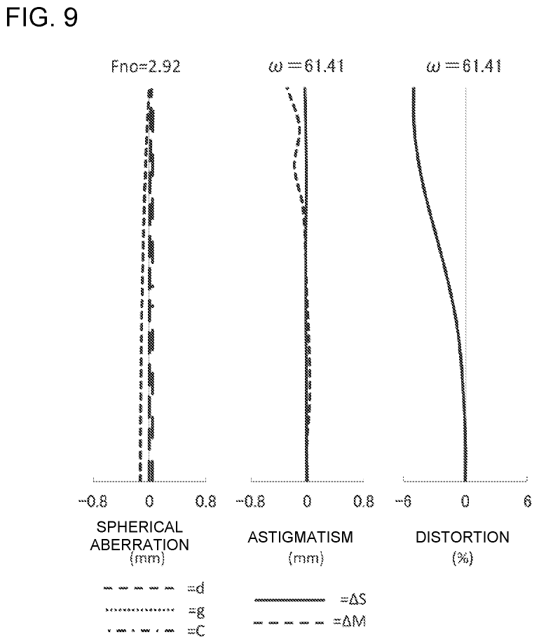

FIG. 10 is a longitudinal aberration diagram of the variable power optical system of the example 2 with focus at infinity at an intermediate focal length;

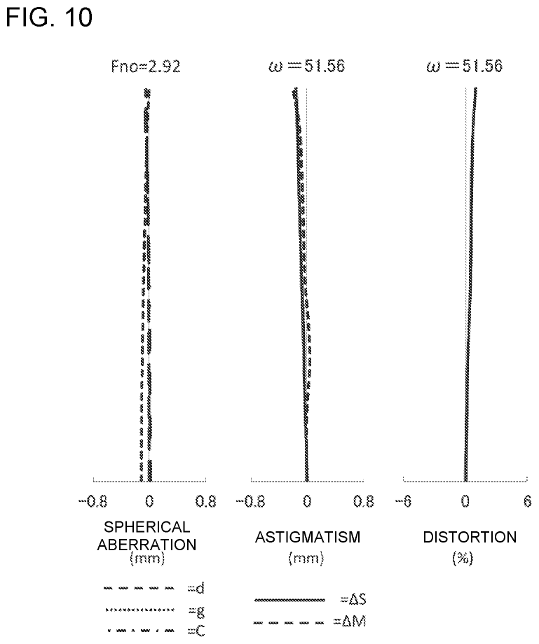

FIG. 11 is a longitudinal aberration diagram of the variable power optical system of the example 2 with focus at infinity at a telephoto end;

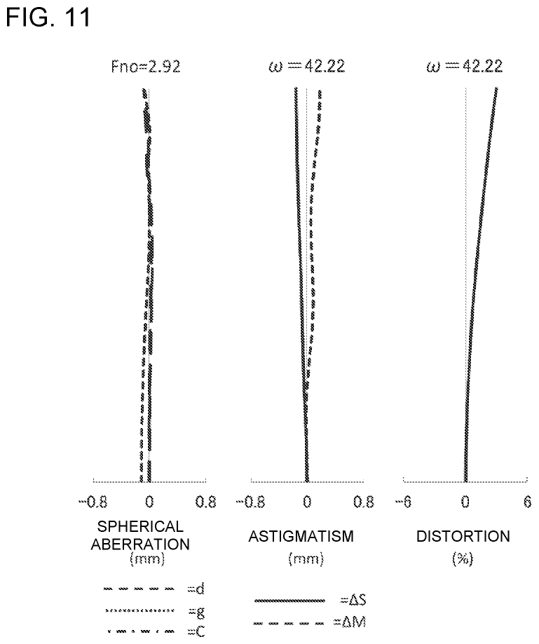

FIG. 12 is a transverse aberration diagram of the variable power optical system of the example 2 with focus at infinity at the wide angle end;

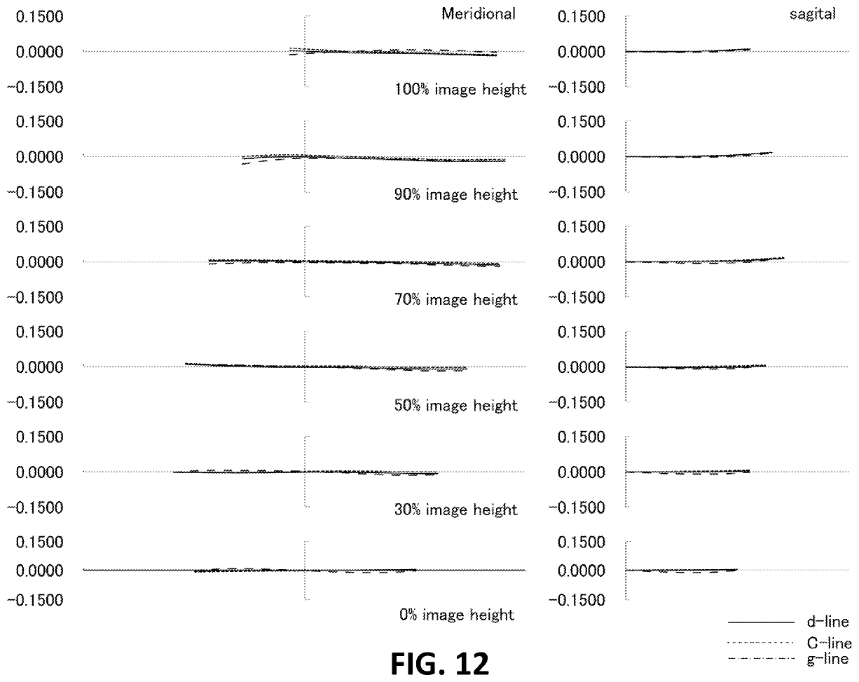

FIG. 13 is a transverse aberration diagram of the variable power optical system of the example 2 with focus at infinity at the intermediate focal length;

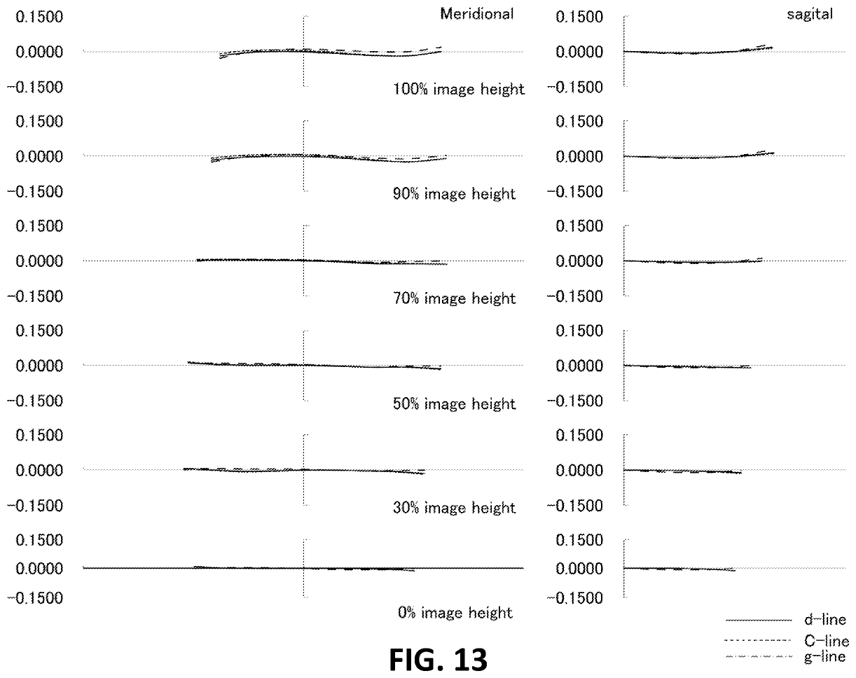

FIG. 14 is a transverse aberration diagram of the variable power optical system of the example 2 with focus at infinity at the telephoto end;

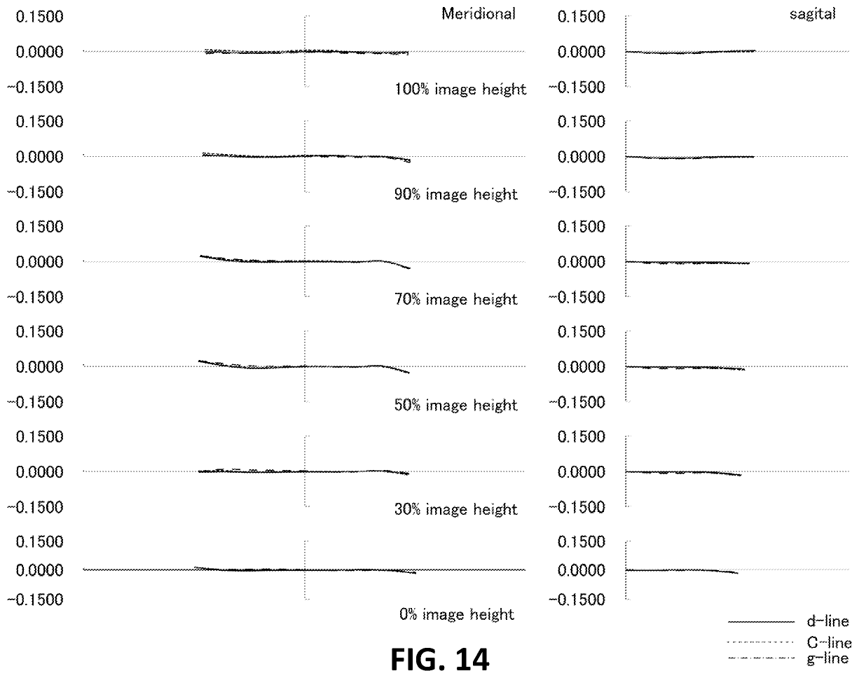

FIG. 15 is a lens configuration diagram of an optical system of an example 3 with focus at infinity;

FIG. 16 is a longitudinal aberration diagram of the optical system of the example 3 with focus at infinity;

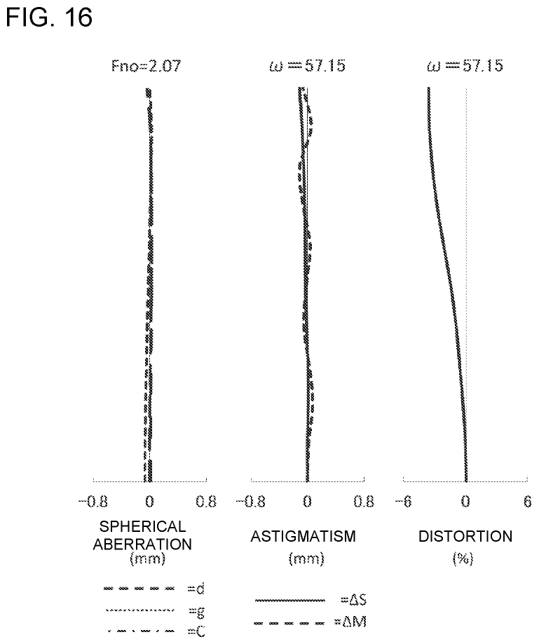

FIG. 17 is a longitudinal aberration diagram of the optical system of the example 3 with a photographing distance of 245 mm;

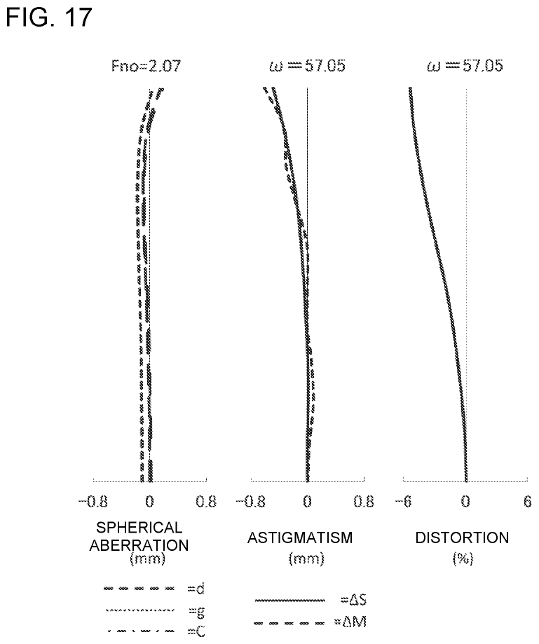

FIG. 18 is a transverse aberration diagram of the optical system of the example 3 with focus at infinity;

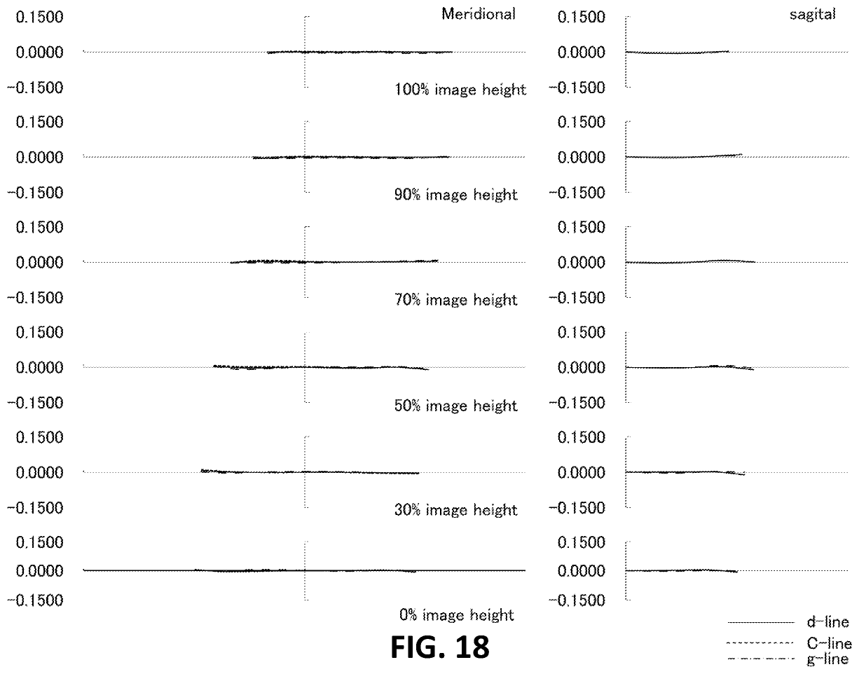

FIG. 19 is a transverse aberration diagram of the optical system of the example 3 with the photographing distance of 245 mm;

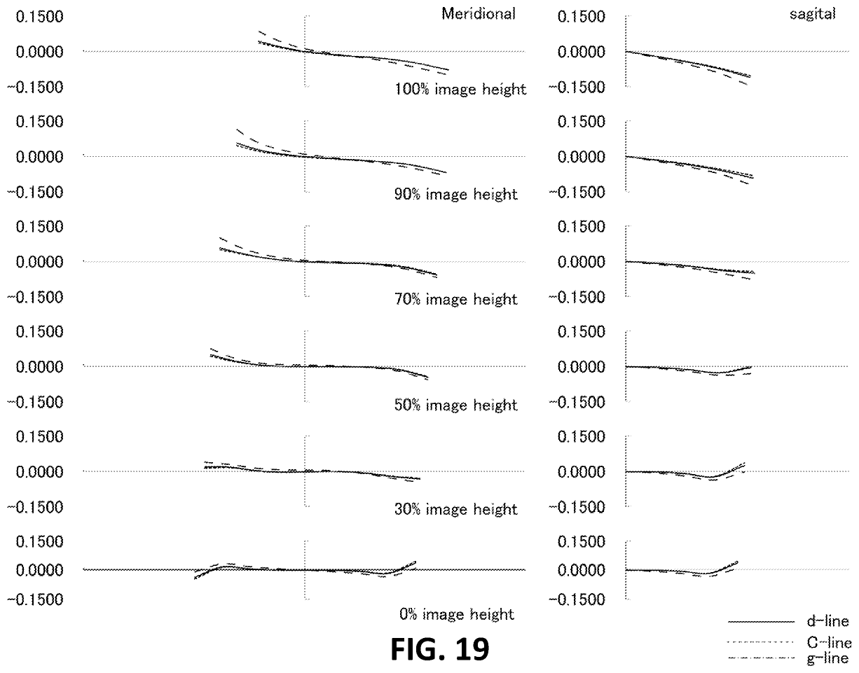

FIG. 20 is a lens configuration diagram of an optical system of an example 4 with focus at infinity;

FIG. 21 is a longitudinal aberration diagram of the optical system of the example 4 with focus at infinity;

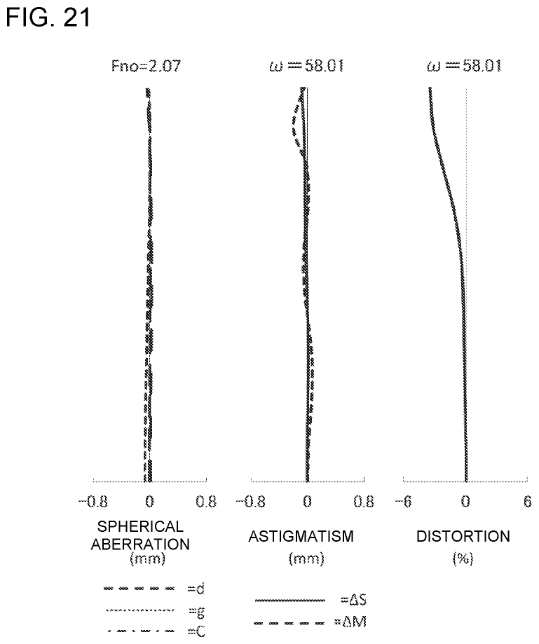

FIG. 22 is a longitudinal aberration diagram of the optical system of the example 4 with a photographing distance of 230 mm;

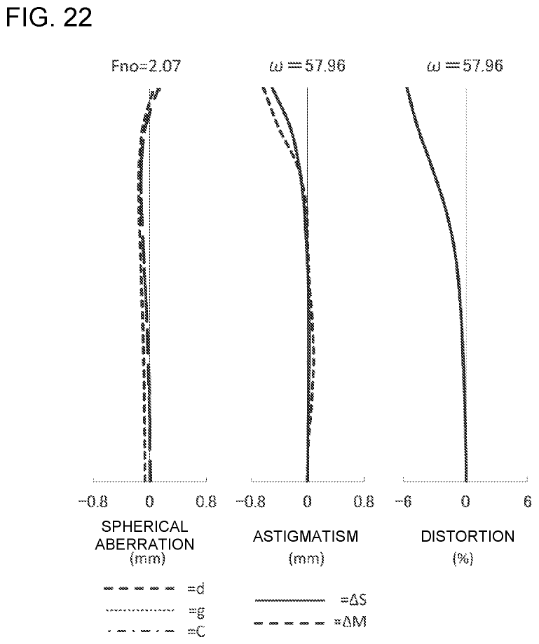

FIG. 23 is a transverse aberration diagram of the optical system of the example 4 with focus at infinity;

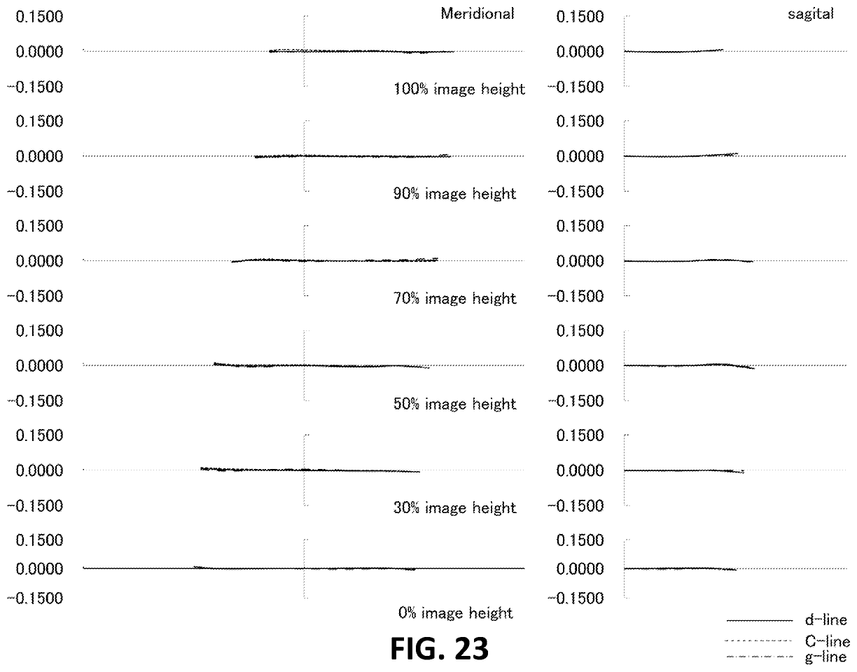

FIG. 24 is a transverse aberration diagram of the optical system of the example 4 with the photographing distance of 230 mm;

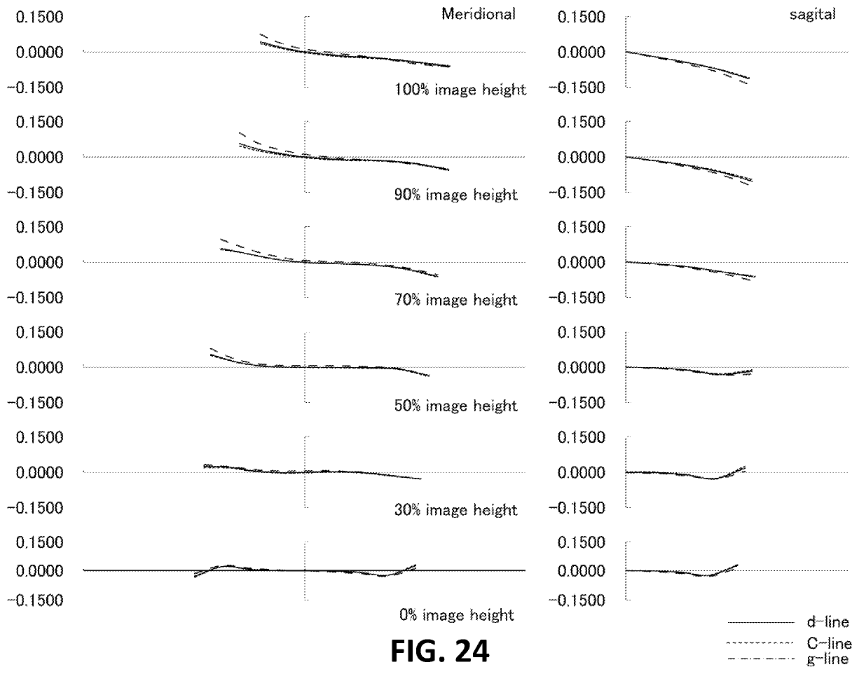

FIG. 25 is a lens configuration diagram of a variable power optical system of an example 5 with focus at infinity at a wide angle end;

FIG. 26 is a longitudinal aberration diagram of the variable power optical system of the example 5 with focus at infinity at the wide angle end;

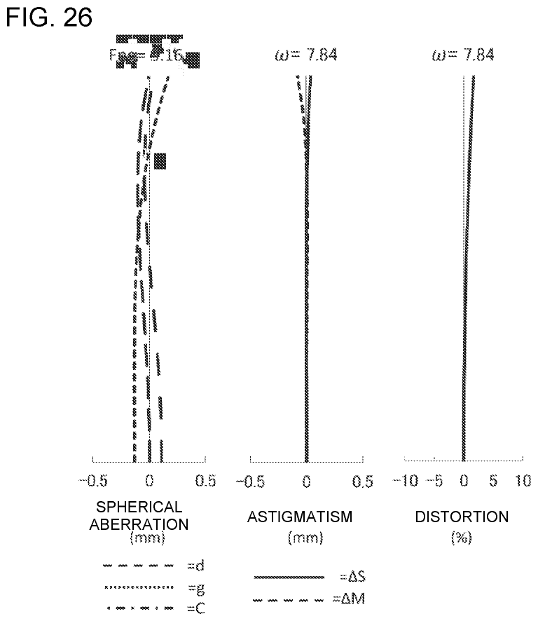

FIG. 27 is a longitudinal aberration diagram of the variable power optical system of the example 5 with focus at infinity at an intermediate focal length;

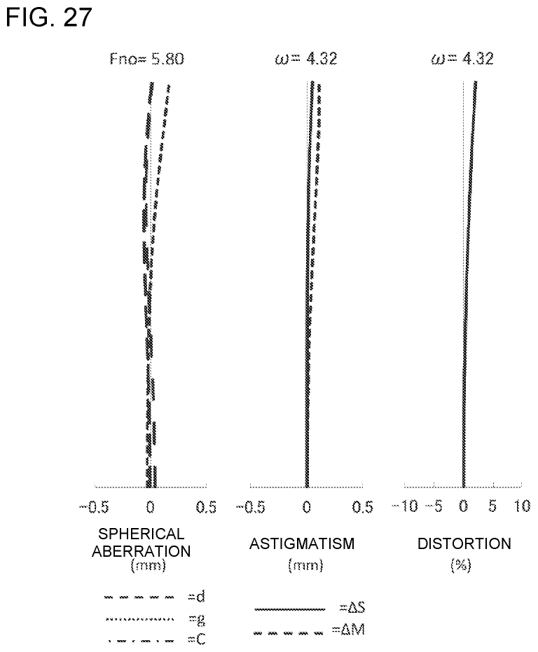

FIG. 28 is a longitudinal aberration diagram of the variable power optical system of the example 5 with focus at infinity at a telephoto end;

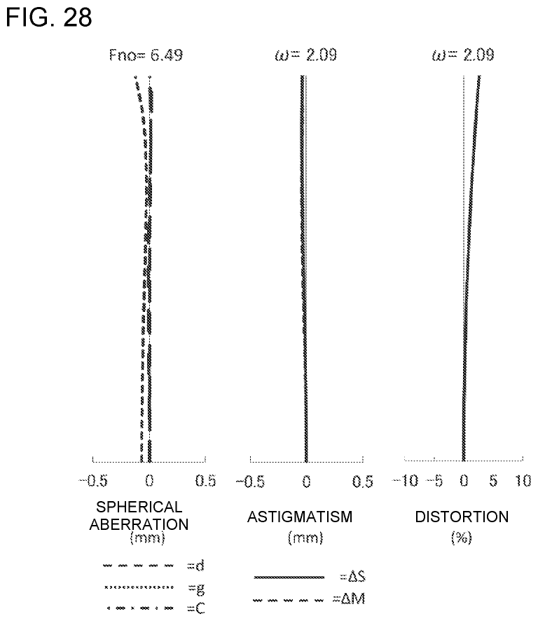

FIG. 29 is a transverse aberration diagram of the variable power optical system of the example 5 with focus at infinity at the wide angle end;

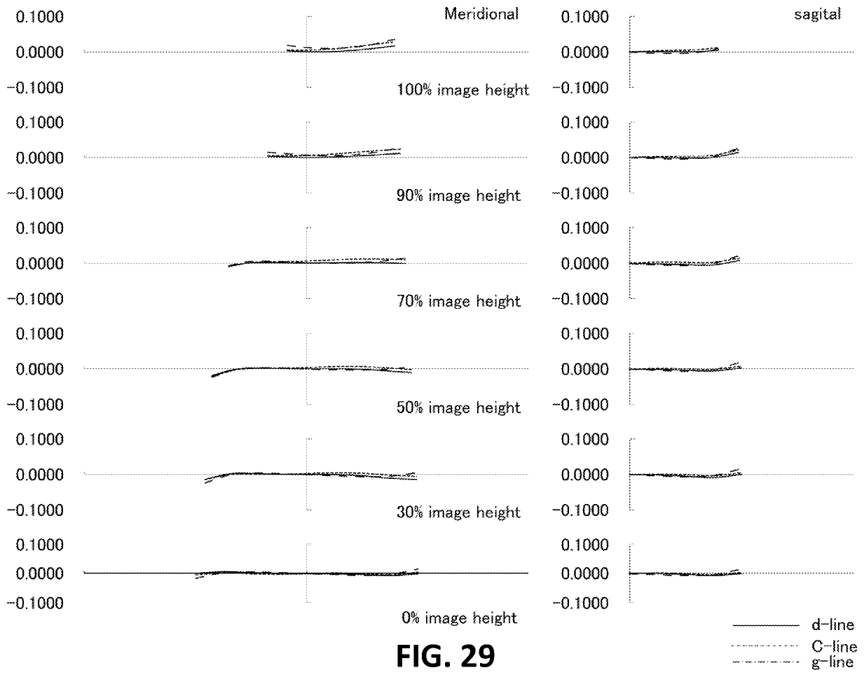

FIG. 30 is a transverse aberration diagram of the variable power optical system of the example 5 with focus at infinity at the intermediate focal length;

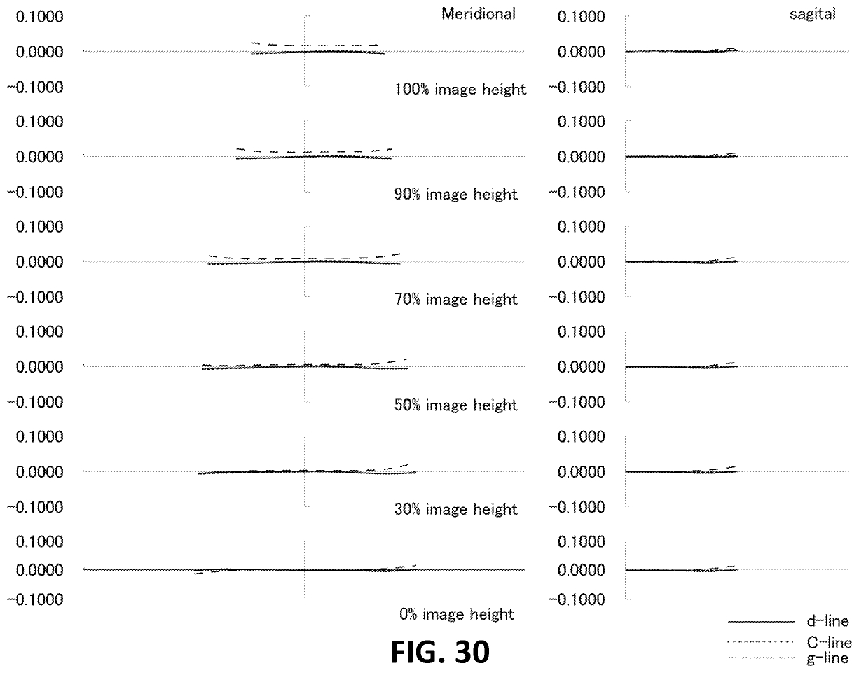

FIG. 31 is a transverse aberration diagram of the variable power optical system of the example 5 with focus at infinity at the telephoto end;

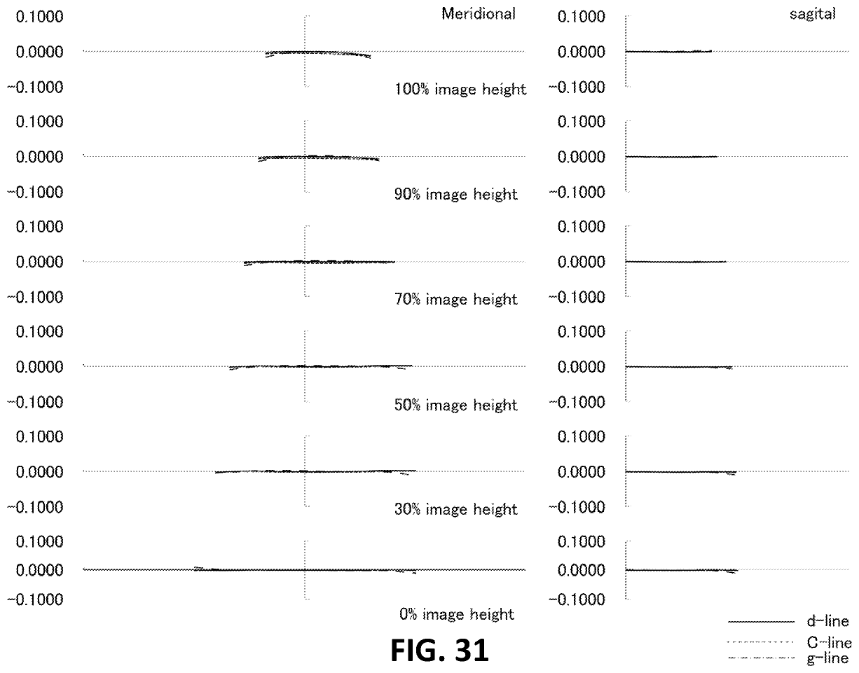

FIG. 32 is a lens configuration diagram of an optical system of an example 6 with focus at infinity;

FIG. 33 is a longitudinal aberration diagram of the optical system of the example 6 with focus at infinity;

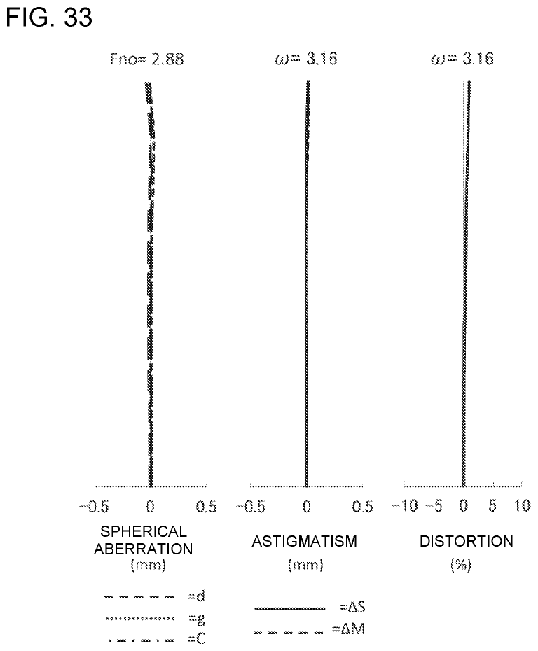

FIG. 34 is a longitudinal aberration diagram of the optical system of the example 6 with a photographing distance of 2675 mm;

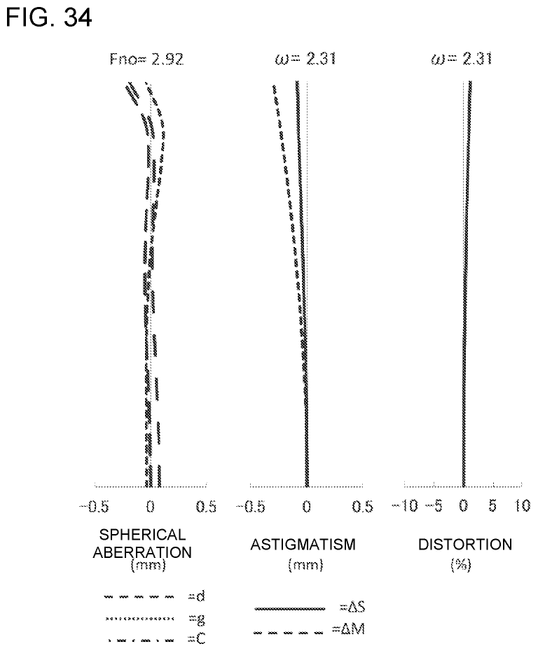

FIG. 35 is a transverse aberration diagram of the optical system of the example 6 with focus at infinity;

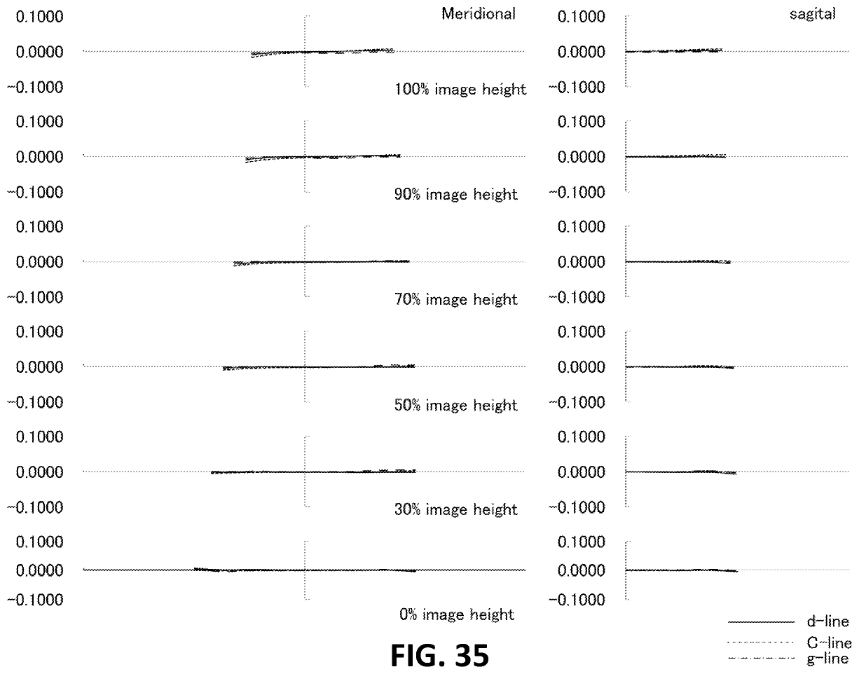

FIG. 36 is a transverse aberration diagram of the optical system of the example 6 with the photographing distance of 2675 mm;

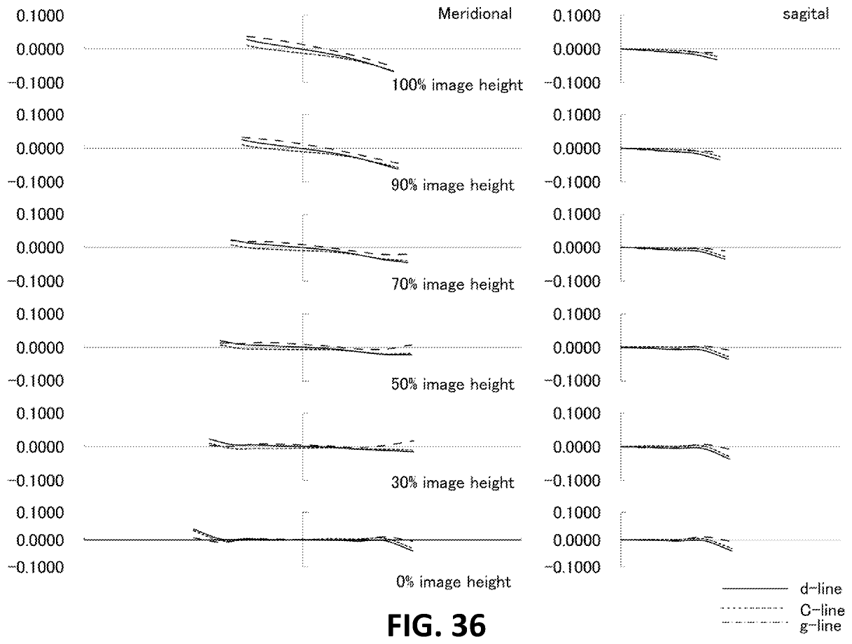

FIG. 37 is a lens configuration diagram of an optical system of an example 7 with focus at infinity;

FIG. 38 is a longitudinal aberration diagram of the optical system of the example 7 with focus at infinity;

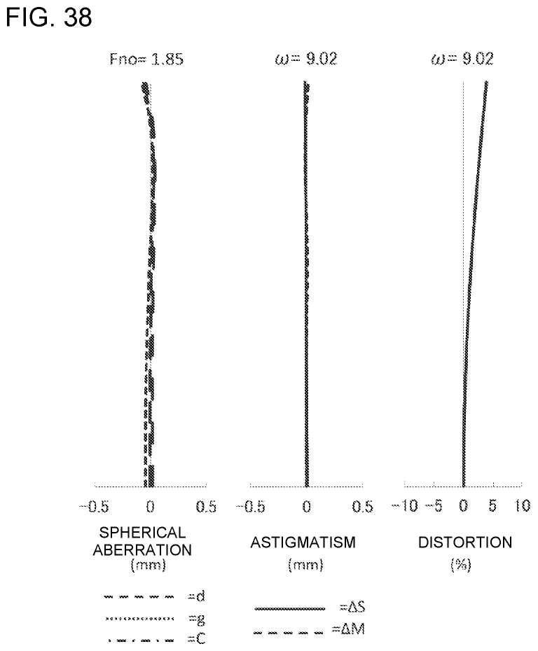

FIG. 39 is a longitudinal aberration diagram of the optical system of the example 7 with a photographing distance of 800 mm;

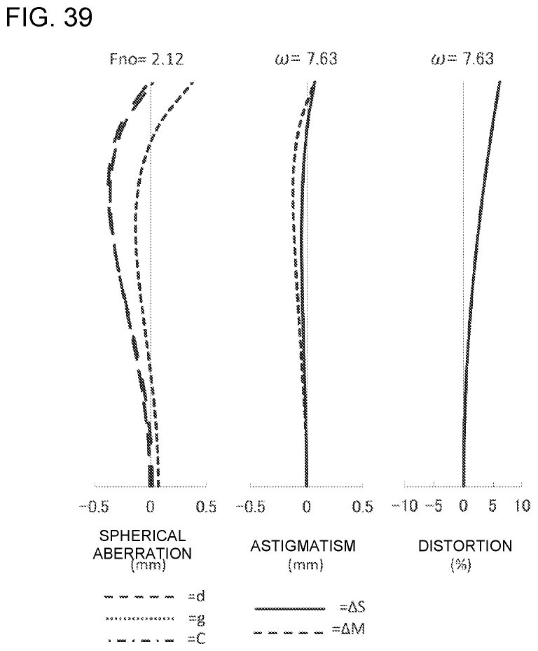

FIG. 40 is a transverse aberration diagram of the optical system of the example 7 with focus at infinity;

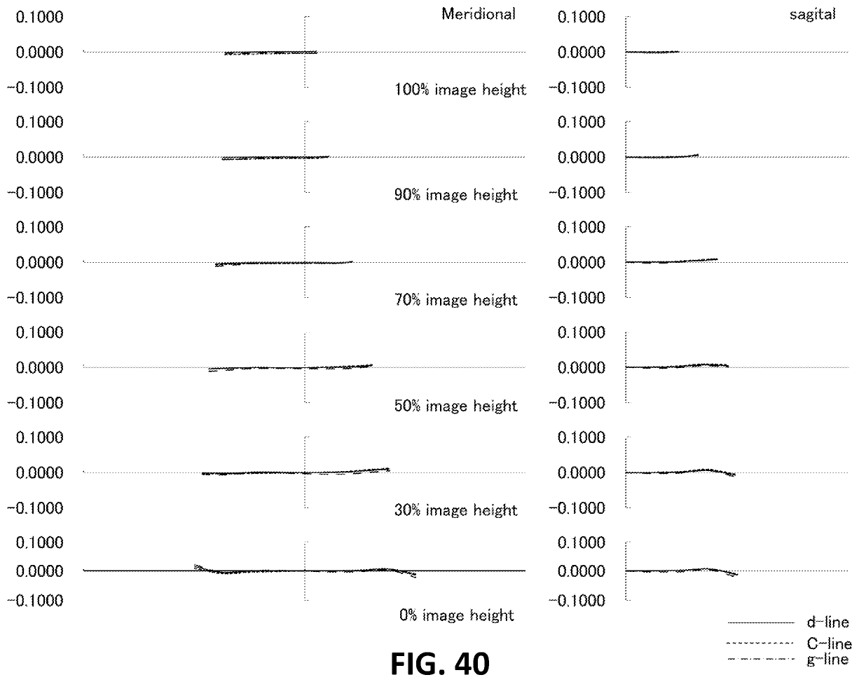

and

FIG. 41 is a transverse aberration diagram of the optical system of the example 7 with the photographing distance of 800 mm.

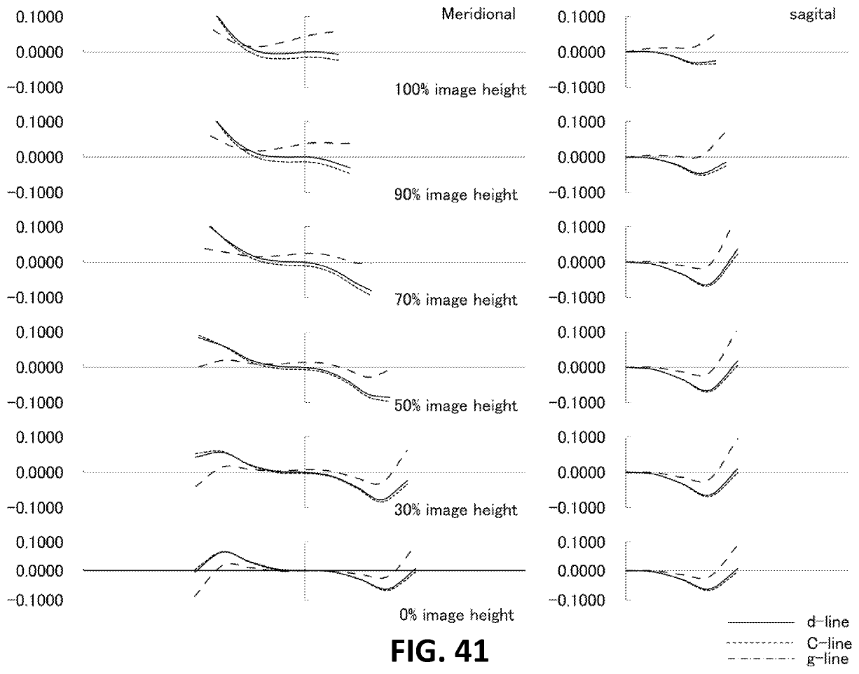

### DETAILED DESCRIPTION OF THE PREFERRED EMBODIMENTS

Hereinafter, examples of an optical system according to the present invention will be described in detail. The examples are given for describing an example of the optical system according to the present invention, and the present invention is not limited to the examples without departing from the gist of the present invention.

It is an object of the present invention to provide an optical system that can preferably correct various aberrations, such as chromatic aberration, therefore it is important to use a glass material suitable for each lens forming the optical system.

Conventionally, as means of simultaneously correcting axial chromatic aberration and magnification chromatic aberration, there is a known technique in which a glass material is fit that has a small wavelength dispersion for the refractive index and has large anomalous dispersibility on the short wavelength side in the vicinity of the g line. However, such glass materials often have a low refractive index in many cases, thus adversely affecting control of aberration at short wavelengths.

Further, in the case where a conventional glass material is used that has small wavelength dispersion for the refractive index and has large anomalous dispersibility on the short wavelength side in the vicinity of the g line, it is difficult to simultaneously correct axial chromatic aberration and magnification chromatic aberration, or it is difficult to correct chromatic aberration in the entire variable power area in a variable power optical system.

For example, a low-dispersion/anomalous dispersion glass, corresponding to calcium fluoride single crystal or to FCD100 made by HOYA CORPORATION, has a high Abbe number and high anomalous dispersibility of the g line, thus effectively correcting first-order spectrum chromatic aberration and second-order spectrum chromatic aberration. However, it is difficult to correct chromatic aberration from the C line to the g line by using such a glass alone.

In view of the above, the optical system according to the present invention uses a glass that corresponds to a low-dispersion oxyfluoride glass described in International Publication No. WO 2017-124612 or to an ultra-low-dispersion fluoride glass K-FIR100UV made by SUMITA OPTICAL GLASS, Inc., to correct axial chromatic aberration and chromatic aberration from the C line to the g line. Further, the optical system according to the present invention suppresses the number of adopted extra-low dispersion glasses to facilitate adoption of glasses having a high refractive index at other positions, thus also suppressing various aberrations, such as astigmatism.

The optical system according to the present invention includes a lens LA that satisfies the following conditional expression (1):

VD_A>96.00 (1)

where
VD_A: the Abbe number of the lens LA based on the d line.

The conditional expression (1) specifies a preferred range of the Abbe number of the lens LA, included by the optical system according to the present invention, for the d line.

When the Abbe number of the lens LA for the d line drops below the lower limit value of the conditional expression (1), the lens LA has insufficient ability to correct chromatic aberration and hence, it becomes difficult for the lens LA to distribute the effects of aberration correction at short wavelengths to other lenses while correcting chromatic aberration.

By setting the lower limit value of the conditional expression (1) to 97.00, it is possible to more surely achieve the advantageous effect of the present invention.

In the optical system according to the present invention, it is also desirable that the lens LA satisfy the following conditional expression (2):

ΔθgF_A>0.057 (2)

where
ΔθgF_A: the mean value of the deviation ΔθgF of the partial dispersion ratio of the lens LA with respect to the g line,
   wherein the deviation ΔθgF of the partial dispersion ratio with respect to the g line is calculated for each lens by

ΔθgF=θgF−(0.648285−0.00180123×VD)
in the case where the partial dispersion ratio with respect to the g line is taken as θgF, and the Abbe number for the d line is taken as VD.

The conditional expression (2) specifies a preferred range of the partial dispersion ratio of the lens LA, included by the optical system according to the present invention, with respect to the g line.

When the mean value of the deviation ΔθgF of the partial dispersion ratio of the lens LA with respect to the g line drops below the lower limit value of the conditional expression (2), it becomes difficult to correct second-order spectrum chromatic aberration.

By setting the lower limit value of the conditional expression (2) to 0.061, it is possible to more surely achieve the advantageous effect of the present invention.

Hereinafter, the description will be made for examples of wide angle/standard optical systems and telephoto optical systems each including the lens LA satisfying the above-mentioned predetermined conditional expressions. In the examples, an example 1 to an example 4 are examples of a wide angle/standard optical system that includes the lens LA, and an example 5 and an example 6 are examples of a telephoto optical system that includes the lens LA.

### First Embodiment (Wide Angle/Standard Optical System)

The example 1 to the example 4 of a wide angle/standard optical system that includes the lens LA will be described.

In the wide angle/standard optical system according to the present invention, an object-side lens group GF and an image-side lens group GR are arranged in order from the object side, the object-side lens group GF has negative refractive power as a whole, the image-side lens group GR has positive refractive power as a whole, and at least either one of the object-side lens group GF or the image-side lens group GR includes the lens LA that satisfies the above-mentioned conditional expressions.

With such a lens configuration, especially in an optical system having a wide angle of view, a back focus can be easily ensured and limb darkening can be easily suppressed.

Alternatively, in the wide angle/standard optical system according to the present invention, the object-side lens group GF and the image-side lens group GR are arranged in order from the object side, an aperture stop is disposed between the object-side lens group GF and the image-side lens group GR, the object-side lens group GF has positive refractive power or negative refractive power as a whole, the image-side lens group GR has positive refractive power as a whole, and at least either one of the object-side lens group GF or the image-side lens group GR includes the lens LA that satisfies the above-mentioned conditional expressions.

With such a lens configuration, especially in an optical system having a wide angle or a standard angle of view, it is possible to easily suppress aberration of light rays incident on an area around a screen while a back focus is ensured.

In the wide angle/standard optical system according to the present invention, it is also desirable that, in the case where the power of the optical system varies, at least a spacing between the object-side lens group GF and the image-side lens group GR change when the power varies, and the lens LA be disposed in the object-side lens group GF and have negative refractive power.

With such a lens configuration, also in an optical system where no power varies and in each variable power state of the optical system where power varies, it is possible to effectively correct magnification chromatic aberration.

In the wide angle/standard optical system according to the present invention, it is also desirable that, in the case where the power of the optical system varies, at least a spacing between the object-side lens group GF and the image-side lens group GR change when the power varies, and the lens LA be disposed in the image-side lens group GR and have positive refractive power.

With such a lens configuration, also in the optical system where no power varies and in each variable power state of the optical system where power varies, it is possible to effectively correct axial chromatic aberration and magnification chromatic aberration.

In the wide angle/standard optical system according to the present invention, it is also desirable that, in the case where power of the optical system varies, with focus at infinity in the maximum wide angle state, or in the case where no power of the optical system varies, with focus at infinity, the largest spacing of air spacings each formed between lenses of the optical system that are adjacent to each other be a spacing between the object-side lens group GF and the image-side lens group GR, and the lens LA be disposed in the object-side lens group GF and have negative refractive power.

With such a lens configuration, also in the optical system where no power varies and at the wide angle end of the optical system where power varies, it is possible to effectively correct magnification chromatic aberration.

In the wide angle/standard optical system according to the present invention, it is also desirable that, in the case where power of the optical system varies, with focus at infinity in the maximum wide angle state, or in the case where no power of the optical system varies, with focus at infinity, the largest spacing of air spacings each formed between lenses of the optical system that are adjacent to each other be a spacing between the object-side lens group GF and the image-side lens group GR, and the lens LA be disposed in the image-side lens group GR and have positive refractive power.

With such a lens configuration, also in the optical system where no power varies and at the wide angle end of the optical system where power varies, it is possible to effectively correct axial chromatic aberration and magnification chromatic aberration.

In the wide angle/standard optical system according to the present invention, it is also desirable that, in the case where the power of the optical system varies, with focus at infinity in the maximum wide angle state, or in the case where no power of the optical system varies, with focus at infinity, the height, from the optical axis, of an axial marginal ray that passes through the aperture stop be greater than the height, from the optical axis, of an axial marginal ray that passes through an optical surface of the optical system that is disposed at a position closest to the object side.

With such a lens configuration, also in the optical system where no power varies and at the wide angle end of the optical system where power varies, back focus can be further easily ensured and limb darkening can be easily suppressed.

In the wide angle/standard optical system according to the present invention, it is also desirable that the optical system include a lens group GFA that includes the lens LA and that has negative refractive power, in the case where the power of the optical system varies, in dividing the object-side lens group GF into lens groups by using, as boundaries, all air spacings that change when the power varies, the lens group GFA be disposed at a position closest to the image-side in the object-side lens group GF, or the lens group GFA be identical with the object-side lens group GF and, in the case where no power of the optical system varies, the lens group GFA be identical with the object-side lens group GF, and the lens group GFA include four or more lenses.

Alternatively, in the wide angle/standard optical system according to the present invention, it is desirable that the optical system include the lens group GFA that includes the lens LA and that has negative refractive power, in the case where the power of the optical system varies, in dividing the object-side lens group GF into lens groups by using, as boundaries, all air spacings that change when the power varies, the lens group GFA be disposed at a position closest to the object side among lens groups included by the object-side lens group GF and having negative refractive power and, in the case where no power of the optical system varies, in dividing the object-side lens group GF into lens groups by using, as boundaries, all air spacings that change when focusing is performed, the lens group GFA be disposed at a position closest to the object side among lens groups included by the object-side lens group GF and having negative refractive power, and the lens group GFA include four or more lenses.

With such a lens configuration, also in the optical system where no power varies and in each variable power state of the optical system where power varies, it is possible to effectively correct various aberrations, such as astigmatism simultaneously with magnification chromatic aberration.

In the wide angle/standard optical system according to the present invention, it is also desirable that the object-side lens group GF have an aspherical surface where positive refractive power increases or negative refractive power decreases with respect to the center of the optical axis in an area around an effective light diameter.

With such a lens configuration, it is possible to effectively correct distortion.

In the wide angle/standard optical system according to the present invention, it is also desirable that the image-side lens group GR have an aspherical surface where positive refractive power decreases or negative refractive power increases with respect to the center of the optical axis in an area around an effective light diameter.

With such a lens configuration, it is possible to effectively correct various aberrations, such as distortion and field curvature.

### Second Embodiment (Telephoto Optical System)

The example 5 to an example 7 of a telephoto optical system that includes the lens LA will be described.

In the telephoto optical system according to the present invention, an object-side lens group GF having positive refractive power and an image-side lens group GR are arranged in order from the object side, an aperture stop is provided, and the telephoto optical system includes the lens LA that satisfies the above-mentioned conditional expressions.

Alternatively, in the telephoto optical system according to the present invention, the object-side lens group GF having positive refractive power and the image-side lens group GR are arranged in order from the object side, the aperture stop is disposed between the object-side lens group GF and the image-side lens group GR, and the telephoto optical system includes the lens LA that satisfies the above-mentioned conditional expressions.

With such a lens configuration, especially in a telephoto optical system, it is possible to easily achieve a reduction in size and weight by reducing the entire length and the diameter of the beam of light.

In the telephoto optical system according to the present invention, it is also desirable that, in the case where the power of the optical system varies, at least a spacing between the object-side lens group GF and the image-side lens group GR change when the power varies, and the lens LA be disposed in the object-side lens group GF and have positive refractive power.

With such a configuration, also in an optical system where no power varies and in each variable power state of the optical system where power varies, it is possible to effectively correct axial chromatic aberration and magnification chromatic aberration.

It is also desirable that the following conditional expression (3) be satisfied:

DAF/f>0.270 (3)

where
in the case where no power of the optical system varies,
DAF: the spacing on the optical axis between the image-side surface of the lens LA disposed in the object-side lens group GF and the aperture stop with focus at infinity
f: the focal length of the optical system with focus at infinity
in the case where the power of the optical system varies,
DAF: the spacing on the optical axis between the image-side surface of the lens LA disposed in the object-side lens group GF and the aperture stop with focus at infinity in the maximum telephoto state
f: the focal length of the optical system with focus at infinity in the maximum telephoto state.

The conditional expression (3) specifies a preferred range of the spacing on the optical axis between the image-side surface of the lens LA disposed in the object-side lens group GF and the aperture stop.

When the spacing on the optical axis between the image-side surface of the lens LA disposed in the object-side lens group GF and the aperture stop drops below the lower limit value of the conditional expression (3), it becomes difficult to effectively correct axial chromatic aberration and magnification chromatic aberration.

In the telephoto optical system according to the present invention, it is also desirable that, in the case where the power of the optical system varies, at least a spacing between the object-side lens group GF and the image-side lens group GR change when the power varies, and the lens LA be disposed in the image-side lens group GR and have negative refractive power.

With such a configuration, also in the optical system where no power varies and in each variable power state of the optical system where power varies, it is possible to effectively correct magnification chromatic aberration.

It is also desirable that the following conditional expression (4) be satisfied:

DAR/f>0.120 (4)

where
in the case where no power of the optical system varies,
DAR: the spacing on the optical axis between the aperture stop and the object-side surface of the lens LA disposed in the image-side lens group GR with focus at infinity
f: the focal length of the optical system with focus at infinity
in the case where the power of the optical system varies,
DAR: the spacing on the optical axis between the aperture stop and the object-side surface of the lens LA disposed in the image-side lens group GR with focus at infinity in the maximum telephoto state
f: the focal length of the optical system with focus at infinity in the maximum telephoto state.

The conditional expression (4) specifies a preferred range of the spacing on the optical axis between the aperture stop and the object-side surface of the lens LA disposed in the image-side lens group GR.

When the spacing on the optical axis between the aperture stop and the object-side surface of the lens LA disposed in the image-side lens group GR drops below the lower limit value of the conditional expression (4), it becomes difficult to effectively correct magnification chromatic aberration.

In the telephoto optical system according to the present invention, it is also desirable that, in the case where power of the optical system varies, with focus at infinity in the maximum telephoto state, or in the case where no power of the optical system varies, with focus at infinity, the largest spacing of air spacings each formed between lenses of the optical system that are adjacent to each other be a spacing between the object-side lens group GF and the image-side lens group GR, and the lens LA be disposed in the object-side lens group GF and have positive refractive power.

With such a configuration, also in the optical system where no power varies and at the telephoto end of the optical system where power varies, it is possible to effectively correct axial chromatic aberration and magnification chromatic aberration.

In the telephoto optical system according to the present invention, it is also desirable that, in the case where power of the optical system varies, with focus at infinity in the maximum telephoto state, or in the case where no power of the optical system varies, with focus at infinity, the largest spacing of air spacings each formed between lenses of the optical system that are adjacent to each other be a spacing between the object-side lens group GF and the image-side lens group GR, and the lens LA be disposed in the image-side lens group GR and have negative refractive power.

With such a configuration, also in the optical system where no power varies and at the telephoto end of the optical system where power varies, it is possible to effectively correct magnification chromatic aberration.

In the telephoto optical system according to the present invention, it is also desirable that the following conditional expression (5) be satisfied:

0.40>DFR/LT>0.10 (5)

where
in the case where no power of the optical system varies,
DFR: the air spacing on the optical axis between the object-side lens group GF and the image-side lens group GR with focus at infinity
LT: the spacing on the optical axis between the surface of the optical system that is disposed at the position closest to the object side and an image plane with focus at infinity
in the case where the power of the optical system varies,
DFR: the air spacing on the optical axis between the object-side lens group GF and the image-side lens group GR with focus at infinity in the maximum telephoto state
LT: the spacing on the optical axis between the surface of the optical system that is disposed at the position closest to the object side and the image plane with focus at infinity in the maximum telephoto state.

The conditional expression (5) specifies a preferred range of the air spacing on the optical axis between the object-side lens group GF and the image-side lens group GR.

When the air spacing on the optical axis between the object-side lens group GF and the image-side lens group GR rises above the upper limit value of the conditional expression (5), it becomes difficult to effectively use, for correcting aberration, the portion occupied by the air spacing along the entire limited length of the optical system, so that it becomes difficult to correct various aberrations, such as distortion, while achieving a reduction in the entire length of the optical system.

When the air spacing on the optical axis between the object-side lens group GF and the image-side lens group GR drops below the lower limit value of the conditional expression (5), a large number of lenses are arranged at positions having large ray heights and hence, it becomes difficult to reduce the weight of the optical system.

By setting the upper limit value of the conditional expression (5) to 0.36, it is possible to more surely achieve the advantageous effect of the present invention.

By setting the lower limit value of the conditional expression (5) to 0.14, it is possible to more surely achieve the advantageous effect of the present invention.

In the telephoto optical system according to the present invention, it is also desirable that, in the case where the power of the optical system varies, with focus at infinity in the maximum telephoto state, or in the case where no power of the optical system varies, with focus at infinity, the height, from the optical axis, of an axial marginal ray that passes through the aperture stop be less than the height, from the optical axis, of an axial marginal ray that passes through the optical surface of the optical system that is disposed at a position closest to the object side.

With such a configuration, also in the optical system where no power varies and at the telephoto end of the optical system where power varies, it is possible to easily suppress the entire length of the optical system and the diameter of the aperture stop.

In the telephoto optical system according to the present invention, it is also desirable that the following conditional expression (6) be satisfied:

0.70>HS/HR1>0.20 (6)

where
in the case where no power of the optical system varies,
HS: the height, from the optical axis, of an axial marginal ray that passes through the aperture stop with focus at infinity
HR1: the height, from the optical axis, of an axial marginal ray that passes through the optical surface of the optical system that is disposed at the position closest to the object side with focus at infinity
in the case where the power of the optical system varies,
HS: the height, from the optical axis, of an axial marginal ray that passes through the aperture stop with focus at infinity in the maximum telephoto state
HR1: the height, from the optical axis, of an axial marginal ray that passes through the optical surface of the optical system that is disposed at the position closest to the object side with focus at infinity in the maximum telephoto state.

The conditional expression (6) specifies a preferred range of the ratio between the height, from the optical axis, of an axial marginal ray that passes through the aperture stop and the height, from the optical axis, of an axial marginal ray that passes through the optical surface of the optical system that is disposed at the position closest to the object side.

When the height, from the optical axis, of the axial marginal ray that passes through the aperture stop becomes relatively high and exceeds the upper limit value of the conditional expression (6), the size of a mechanism, such as a variable stop, increases and, in addition to the above, it becomes difficult to suppress the entire length of the optical system with respect to a focal length.

When the height, from the optical axis, of the axial marginal ray that passes through the aperture stop becomes relatively low and exceeds the lower limit value of the conditional expression (6), it becomes necessary to have a surface having extremely high refractive power to significantly refract the axial marginal ray. Therefore, various aberrations, such as spherical aberration, are worsened and, in addition to the above, performance is liable to be reduced due to eccentricity or the like.

By setting the upper limit value of the conditional expression (6) to 0.60, it is possible to more surely achieve the advantageous effect of the present invention.

By setting the lower limit value of the conditional expression (6) to 0.25, it is possible to more surely achieve the advantageous effect of the present invention.

Hereinafter, the description will be made for the wide angle/standard optical system and the telephoto optical system according to the present invention with respect to lens configurations of respective examples, numerical examples, and values corresponding to the conditional expressions. In the description made hereinafter, the lens configurations are described in order from the object side to the image-side.

In [Surface data], “surface number” denotes the number of a lens surface or an aperture stop counted from the object side, “r” denotes the radius of curvature of each lens surface, “d” denotes the spacing between respective lens surfaces, “nd” denotes the refractive index with respect to the d line (wavelength 587.56 nm), “vd” denotes the Abbe number with respect to the d line, and “θgF” denotes the partial dispersion ratio between the g line (wavelength 435.84 nm) and the F line (wavelength 486.13 nm).
a surface number labeled with an asterisk (*) denotes that the shape of the lens surface is an aspherical shape. Further, “BF” denotes back focus, and the distance from an object surface denotes the distance from an object to the first surface of a lens.

A surface number labeled with (stop) denotes that an aperture stop is located at such a position. For the radius of curvature of a plane or an aperture stop, ∞ (infinity) is written.

[Aspherical surface data] shows values of respective coefficients for an aspherical shape for lens surfaces labeled with * in [Surface data]. The shape of an aspherical surface is expressed by the following equation. In the following equation, the displacement in the direction orthogonal to the optical axis from the optical axis is denoted by “y”, the displacement (amount of sag) from a point of intersection between an aspherical surface and the optical axis in the direction of the optical axis is denoted by “z”, the radius of curvature of a reference spherical surface is denoted by “r”, and the conic coefficient is denoted by “K”. Further, 3rd, 4th, 5th, 6th, 7th, 8th, 9th, 10th, 11th, 12th, 13th, 14th, 15th, and 16th order aspherical coefficients are respectively denoted by A3, A4, A5, A6, A7, A8, A9, A10, A11, A12, A13, A14, A15, and A16.

### [Expression 1]

[Various data] shows values of focal length and the like for respective focal length states or respective photographing distance focus states.

[Variable spacing data] shows values of variable spacing and BF for respective focal length states or respective photographing distance focus states.

[Lens group data] shows the number of surfaces each disposed at a position closest to the object side and each forming each lens group and the composite focal length of each entire group.

In the aberration diagrams that correspond to respective examples, “d”, “g”, and “C” respectively denote the d line, the g line, and the C line, and “ΔS” and “ΔM” respectively denote a sagittal image plane and a meridional image plane.

For all values of specifications described below, millimeter (mm) is used as the unit for the focal length f, the radius of curvature r, the lens surface spacing d, and other lengths unless otherwise indicated. However, in an optical system, equivalent optical performance can also be obtained in proportional expansion and proportional reduction and hence, the unit is not limited to the above.

### Example 1

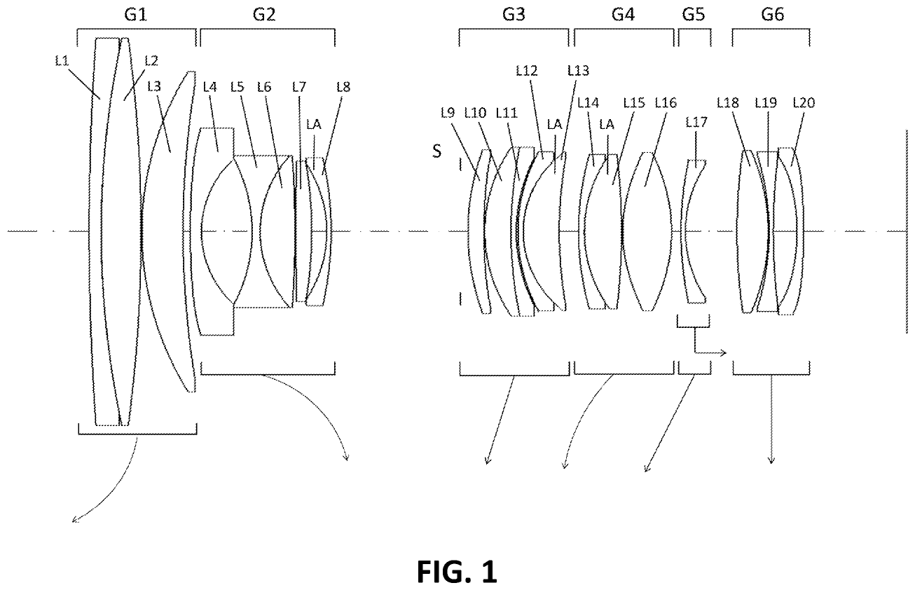

FIG. 1 is a lens configuration diagram of a variable power optical system of the example 1 of the present invention.

The variable power optical system of the example 1 includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power. When power is varied from the wide angle end to the telephoto end, a spacing between the first lens group G1 and the second lens group G2 increases, a spacing between the second lens group G2 and the third lens group G3 reduces, a spacing between the third lens group G3 and the fourth lens group G4 reduces, a spacing between the fourth lens group G4 and the fifth lens group G5 increases and, thereafter, reduces, and a spacing between the fifth lens group G5 and the sixth lens group G6 increases. When power is varied, the sixth lens group G6 is fixed with respect to the image plane.

A composite group of the first lens group G1 and the second lens group G2 corresponds to the object-side lens group GF in claim 1 to claim 6, a composite group of the third lens group G3 to the sixth lens group G6 corresponds to the image-side lens group GR in claim 1 to claim 6, and the second lens group G2 corresponds to the lens group GFA that includes the lens LA in claim 7.

A composite group of the first lens group G1 and the second lens group G2 corresponds to the object-side lens group GF in claim 10 to claim 14, a composite group of the third lens group G3 to the sixth lens group G6 corresponds to the image-side lens group GR in claim 10 to claim 14, and the second lens group G2 corresponds to the lens group GFA that includes the lens LA in claim 15.

An aperture stop S is disposed between the second lens group G2 and the third lens group G3.

The first lens group G1 includes, in order from the object side, a cemented lens that includes a negative meniscus lens L1 with the convex surface facing the object side and a biconvex lens L2, and a positive meniscus lens L3 with the convex surface facing the object side.

The second lens group G2 includes, in order from the object side, a negative meniscus lens L4 with the convex surface facing the object side, a cemented lens that includes a biconcave lens L5 and a biconvex lens L6, a biconvex lens L7, and a negative meniscus lens L8 with the convex surface facing the image-side, and the lens surfaces of the negative meniscus lens L4 on both sides have predetermined aspherical shapes. The negative meniscus lens L8 corresponds to the lens LA in the present invention.

The third lens group G3 includes, in order from the object side, a positive meniscus lens L9 with the convex surface facing the object side, a cemented lens that includes a positive meniscus lens L10 with the convex surface facing the object side and a negative meniscus lens L11 with the convex surface facing the object side, and a cemented lens that includes a negative meniscus lens L12 with the convex surface facing the object side and a positive meniscus lens L13 with the convex surface facing the object side, and the lens surfaces of the positive meniscus lens L9 on both sides have predetermined aspherical shapes. The positive meniscus lens L13 corresponds to the lens LA in the present invention.

The fourth lens group G4 includes, in order from the object side, a cemented lens that includes a negative meniscus lens L14 with the convex surface facing the object side and a biconvex lens L15, and a biconvex lens L16, and the lens surfaces of the biconvex lens L16 on both sides have predetermined aspherical shapes. The biconvex lens L15 corresponds to the lens LA in the present invention.

The fifth lens group G5 includes, in order from the object side, only a negative meniscus lens L17 with the convex surface facing the object side. In focusing from an infinite object distance to a short distance, the entire fifth lens group G5 moves toward the image-side.

The sixth lens group G6 includes a biconvex lens L18, a biconcave lens L19, and a negative meniscus lens L20 with the convex surface facing the image-side, and the lens surfaces of the negative meniscus lens L20 on both sides have predetermined aspherical shapes.

Specification values of the optical system according to the example 1 are shown below.

### Numerical Example 1

Unit: mm

### [Surface Data]

Surface number r d nd vd θgF
Object surface ∞ (d0)
1 672.5318 2.5000 1.92286 20.88 0.638840
2 223.7090 8.2551 1.55032 75.50 0.539881
3 −354.6280 0.1500
4 72.3861 8.5434 1.75500 52.32 0.547242
5 225.2088 (d5)
6* 212.1689 2.3000 1.77250 49.50 0.551804
7* 23.4631 10.4743
8−37.5554 1.6635 1.59282 68.62 0.544009
9 26.8746 7.2057 1.75500 52.32 0.547242
10 −259.9052 0.1500
11 770.2718 3.3191 2.00100 29.13 0.599373
12 −100.6859 3.1153
13 −29.5029 0.9000 1.41390 100.82 0.533605
14 −80.2315 (d14)
15 (stop) ∞ 1.5000
16* 54.1542 3.3572 1.55332 71.68 0.540167
17* 133.5316 0.1500
18 35.6379 5.4355 1.92286 20.88 0.638840
19 100.5624 1.1000 1.77047 29.74 0.594996
20 38.9981 0.3135
21 39.6115 1.1000 1.85451 25.15 0.610160
22 23.3180 7.4617 1.41390 100.82 0.533605
23 103.9434 (d23)
24 68.3190 1.2000 1.85451 25.15 0.610160
25 31.5332 7.7102 1.41390 100.82 0.533605
26 −151.3755 0.2323
27* 34.4957 10.1222 1.59201 67.02 0.535765
28* −38.5287 (d28)
29 84.1341 0.9000 1.91082 35.25 0.582104
30 29.1111 (d30)
31 139.8664 6.4702 2.00100 29.13 0.599373
32 −48.4533 0.1500
33 −62.5586 0.9000 1.73037 32.23 0.589819
34 153.1720 4.9045
35* −47.2352 1.3500 1.58313 59.46 0.540428
36* −145.3412 (BF)
Image plane ∞

### [Aspherical Surface Data]

6th surface 7th surface 16th surface 17th surface
K 0.00000 0.00000 0.00000 0.00000
A4 2.51576E−07 −2.94360E−06 −3.49364E−06 7.49274E−08
A6 1.94291E−08 1.97402E−08 1.20715E−08 1.57632E−08
A8 −7.87263E−11 −2.23590E−11 −9.32398E−12 −7.62943E−12
A10 1.86394E−13 −8.03218E−14 −3.44187E−14 −3.63402E−14
A12 −2.35091E−16 3.29341E−16 0.00000E+00 0.00000E+00
A14 1.29558E−19 0.00000E+00 0.00000E+00 0.00000E+00
27th surface 28th surface 35th surface 36th surface
K 0.00000 0.00000 0.00000 0.00000
A4 −7.54571E−06 5.24520E−06 6.33827E−07 2.39126E−06
A6 −1.04713E−09 −9.06910E−09 −3.85594E−08 −4.11777E−08
A8 2.04182E−12 1.12469E−11 4.89128E−12 3.29571E−11
A10 −1.86264E−14 −1.87968E−14 5.03597E−14 −9.46789E−15
A12 2.67430E−17 1.57087E−17 −6.61740E−17 9.29198E−18
A14 0.00000E+00 0.00000E+00 0.00000E+00 0.00000E+00

### [Various Data]

Zoom ratio 2.34
Wide angle intermediate telephoto
Focal length 28.90 49.99 67.75
F-number 2.07 2.07 2.07
Total angle of view 2ω 76.74 45.57 33.8
Image height Y 21.63 21.63 21.63
Entire length of lens 169.15 171.89 184.16

### [Variable Spacing Data]

Wide angle intermediate telephoto
d0 ∞ ∞ ∞
d5 1.5000 17.2434 31.2233
d14 26.7966 6.2404 2.0000
d23 3.9900 2.5649 1.5000
d28 1.9500 3.6671 2.7564
d30 10.6818 17.9447 22.4440
BF 21.2980 21.2980 21.2980

### [Lens Group Data]

### Group Start Surface Focal Length

G1 1 117.28
G2 6 −29.60
G3 15 79.54
G4 24 31.19
G5 29 −49.26
G6 31 262.47

### Example 2

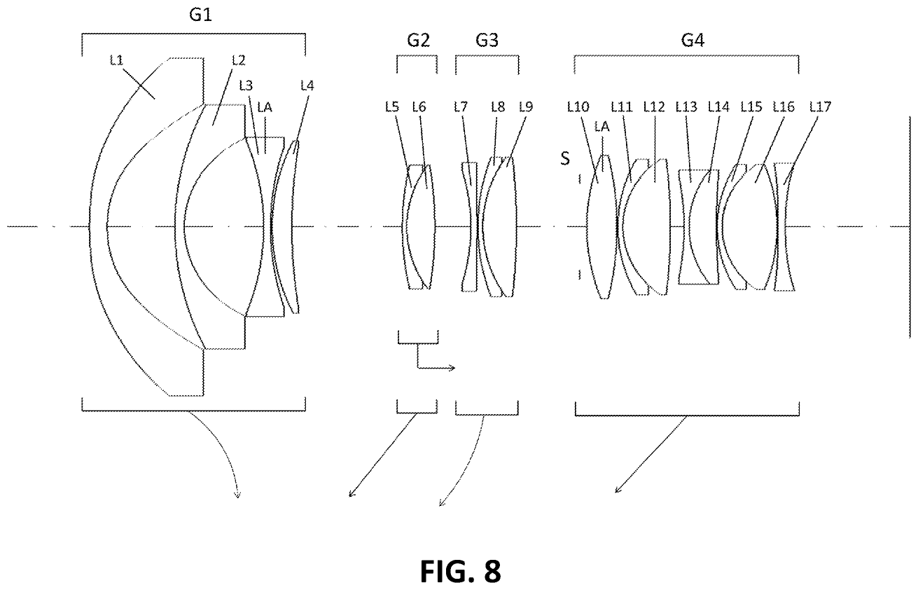

FIG. 8 is a lens configuration diagram of a variable power optical system of the example 2 of the present invention.

The variable power optical system of the example 2 includes, in order from the object side, a first lens group G1 having negative refractive power, a second lens group G2 having positive refractive power, a third lens group G3 having positive refractive power, and a fourth lens group G4 having positive refractive power. When power is varied from the wide angle end to the telephoto end, a spacing between the first lens group G1 and the second lens group G2 reduces, a spacing between the second lens group G2 and the third lens group G3 increases and, thereafter, reduces, and a spacing between the third lens group G3 and the fourth lens group G4 reduces.

The first lens group G1 corresponds to the object-side lens group GF in claim 1 to claim 6 and corresponds to the lens group GFA that includes the lens LA in claim 7, and a composite group of the second lens group G2 to the fourth lens group G4 corresponds to the image-side lens group GR in claim 1 to claim 6.

A composite group of the first lens group G1 to the third lens group G3 corresponds to the object-side lens group GF in claim 10 to claim 14, the first lens group G1 corresponds to the lens group GFA that includes the lens LA in claim 15, and the fourth lens group G4 corresponds to the image-side lens group GR in claim 10 to claim 14.

An aperture stop S is disposed between the third lens group G3 and the fourth lens group G4.

The first lens group G1 includes, in order from the object side, a negative meniscus lens L1 with the convex surface facing the object side, a negative meniscus lens L2 with the convex surface facing the object side, a biconcave lens L3, and a positive meniscus lens L4 with the convex surface facing the object side, and the lens surfaces of the negative meniscus lens L1 on both sides have predetermined aspherical shapes. The biconcave lens L3 corresponds to the lens LA in the present invention.

The second lens group G2 includes only a cemented lens that includes a negative meniscus lens L5 with the convex surface facing the object side and a biconvex lens L6. In focusing from an infinite object distance to a short distance, the second lens group G2 moves toward the image-side.

The third lens group G3 includes, in order from the object side, a negative meniscus lens L7 with the convex surface facing the image-side, and a cemented lens that includes a negative meniscus lens L8 with the convex surface facing the object side and a biconvex lens L9, and the lens surfaces of the negative meniscus lens L7 on both sides have predetermined aspherical shapes.

The fourth lens group G4 includes, in order from the object side, a biconvex lens L10, a cemented lens that includes a negative meniscus lens L11 with the convex surface facing the object side and a biconvex lens L12, a cemented lens that includes a biconcave lens L13 and a positive meniscus lens L14 with the convex surface facing the object side, a cemented lens that includes a negative meniscus lens L15 with the convex surface facing the object side and a biconvex lens L16, and a biconcave lens L17, and the lens surfaces of the biconcave lens L17 on both sides have predetermined aspherical shapes. The biconvex lens L10 corresponds to the lens LA in the present invention.

Specification values of the optical system according to the example 2 are shown below.

### Numerical Example 2

Unit: mm

### [Surface Data]

Surface number r d nd vd θgF
Object surface 00 (d0)
1* 84.2242 3.2000 1.69350 53.18 0.548185
2* 24.7641 12.2180
3 54.3275 1.7000 1.88100 40.14 0.569968
4 19.2421 14.3104
46.8729 1.2500 1.41390 100.82 0.533605
6 51.8469 0.2858
7 39.4670 3.5474 1.86966 20.02 0.643332
8 102.9982 (d8)
9 56.3987 0.8000 2.00069 25.46 0.613492
10 21.2660 5.0673 1.73037 32.23 0.589819
11 −78.1393 (d11)
12* −38.1015 1.1054 1.85135 40.10 0.569406
13* −336.5447 0.1500
14 40.1135 0.9000 1.92286 20.88 0.638840
15 24.4027 6.0529 1.71736 29.50 0.603381
16 −132.0011 (d16)
17 (stop) ∞ 1.2400
18 39.9349 5.4590 1.41390 100.82 0.533605
19 −61.8782 0.1500
20 28.0224 0.9000 1.77047 29.74 0.594996
21 16.3856 8.6036 1.55032 75.50 0.539881
22 −111.2533 2.4420
23 −52.8314 0.9000 1.95375 32.32 0.590002
24 18.5517 4.9231 1.92286 20.88 0.638840
25 128.8227 0.1500
26 23.6476 0.9000 1.90043 37.37 0.576542
27 15.1999 9.9268 1.49700 81.61 0.538747
28 −33.5096 0.1500
29* −300.0000 1.3000 1.80610 40.73 0.569264
30 53.0620 (BF)
Image plane ∞

### [Aspherical Surface Data]

1st surface 2nd surface 12th surface 13th surface
K 0.00000 −0.59024 0.00000 0.00000
A4 3.14115E−05 3.57246E−05 5.87260E−07 1.33089E−06
A6 −9.30287E−08 −2.21252E−08 9.54963E−08 8.27963E−08
A8 1.78995E−10 −4.09995E−10 −1.05725E−09 −9.67519E−10
A10 −2.19064E−13 1.97208E−12 5.82638E−12 5.47255E−12
A12 1.65913E−16 −4.24159E−15 −1.13951E−14 −1.13990E−14
A14 −7.04547E−20 4.49697E−18 0.00000E+00 0.00000E+00
A16 1.29362E−23 −1.89109E−21 0.00000E+00 0.00000E+00
29th surface 30th surface
K 0.00000 0.00000
A4 −1.36584E−05 1.32575E−05
A6 −4.65492E−07 −4.66888E−07
A8 1.25901E−08 1.24064E−08
A10 −1.70606E−10 −1.63327E−10
A12 1.26500E−12 1.16770E−12
A14 −4.79106E−15 −4.29296E−15
A16 7.22467E−18 6.28893E−18

### [Various Data]

Zoom ratio 1.87
Wide angle intermediate telephoto
Focal length 12.40 17.00 23.15
F-number 2.92 2.92 2.92
Total angle of view 2ω 122.82 103.12 84.4
Image height Y 21.63 21.63 21.63
Entire length of lens 148.00 142.30 141.41

### [Variable Spacing Data]

Wide angle intermediate telephoto
d0 ∞ ∞ ∞
d8 19.9537 9.4612 3.1500
d11 6.5022 9.0635 7.8411
d16 11.4721 5.1519 1.4000
BF 22.4402 30.9877 41.3850

### [Lens Group Data]

### Group Start Surface Focal Length

G1 1 −16.16
G2 9 70.11
G3 12 1503.78
G4 17 43.21

### Example 3

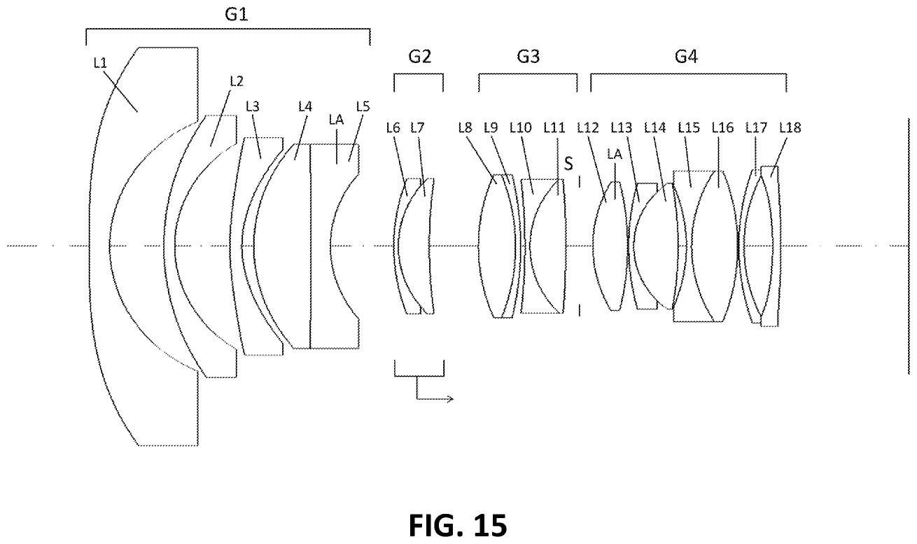

FIG. 15 is a lens configuration diagram of an optical system of the example 3 of the present invention.

The optical system of the example 3 includes, in order from the object side, a first lens group G1 having negative refractive power, a second lens group G2 having positive refractive power, a third lens group G3 having positive refractive power, and a fourth lens group G4 having positive refractive power.

The first lens group G1 corresponds to the object-side lens group GF in claim 1 to claim 6 and corresponds to the lens group GFA that includes the lens LA in claim 7, and a composite group of the second lens group G2 to the fourth lens group G4 corresponds to the image-side lens group GR in claim 1 to claim 6.

A composite group of the first lens group G1 to the third lens group G3 corresponds to the object-side lens group GF in claim 10 to claim 14, the first lens group G1 corresponds to the lens group GFA that includes the lens LA in claim 15, and the fourth lens group G4 corresponds to the image-side lens group GR in claim 10 to claim 14.

An aperture stop S is disposed between the third lens group G3 and the fourth lens group G4.

The first lens group G1 includes, in order from the object side, a negative meniscus lens L1 with the convex surface facing the object side, a negative meniscus lens L2 with the convex surface facing the object side, a negative meniscus lens L3 with the convex surface facing the object side, and a cemented lens that includes a biconvex lens L4 and a biconcave lens L5, and the lens surface of the negative meniscus lens L1 on the object side and the lens surfaces of the negative meniscus lens L3 on both sides have predetermined aspherical shapes. The biconcave lens L5 corresponds to the lens LA in the present invention.

The second lens group G2 includes only a cemented lens that includes a negative meniscus lens L6 with the convex surface facing the object side and a positive meniscus lens L7 with the convex surface facing the object side. In focusing from an infinite object distance to a short distance, the second lens group G2 moves toward the image-side.

The third lens group G3 includes, in order from the object side, a cemented lens that includes a biconvex lens L8 and a negative meniscus lens L9 with the convex surface facing the image side, and a cemented lens that includes a biconcave lens L10 and a biconvex lens L11.

The fourth lens group G4 includes, in order from the object side, a biconvex lens L12, a cemented lens that includes a negative meniscus lens L13 with the convex surface facing the object side and a biconvex lens L14, a cemented lens that includes a biconcave lens L15 and a biconvex lens L16, a negative meniscus lens L17 with the convex surface facing the object side, and a negative meniscus lens L18 with the convex surface facing the image-side, and the lens surfaces of the negative meniscus lens L18 on both sides have predetermined aspherical shapes. The biconvex lens L12 corresponds to the lens LA in the present invention.

Specification values of the optical system according to the example 3 are shown below.

### Numerical Example 3

Unit: mm

### [Surface Data]

Surface number r d nd vd θgF
Object surface ∞ (d0)
1* 557.0263 3.2000 1.69350 53.18 0.548185
2 23.1636 8.4495
3 40.4452 1.7000 1.59282 68.62 0.544009
4 20.6555 8.6089
5 43.0482 1.8800 1.59201 67.02 0.535765
6* 18.9983 1.8639
7 27.1416 8.9531 1.85451 25.15 0.610160
8 −749.3128 2.9989 1.41390 100.82 0.533605
9 19.3594 (d9)
10 33.4363 0.7000 2.00069 25.46 0.613492
11 16.7938 4.8268 1.75211 25.05 0.619087
12 87.8644 (d12)
13 31.9306 5.7987 1.90043 37.37 0.576542
14 −34.7272 0.8000 1.92286 20.88 0.638840
15 55.6678 0.6525
16 −110.7050 0.8000 2.00100 29.13 0.599373
17 16.4803 5.5833 1.59349 67.00 0.536541
18 −152.6016 2.1784
19 (stop) ∞ 2.0527
20 22.4831 5.4394 1.41390 100.82 0.533605
21 −48.0693 0.1511
22 42.2433 0.8000 1.88300 40.80 0.565434
23 13.5353 6.9022 1.55032 75.50 0.539881
24 −63.8490 1.3077
25 27.4669 0.8000 1.73037 32.23 0.589819
26 24.7307 7.2312 1.92286 20.88 0.638840
27 −35.8817 0.1500
28 41.0230 0.8000 1.85451 25.15 0.610160
29 28.1086 4.4917
30 54.3848 1.3000 1.69350 53.20 0.546484
31* −106.5247 (BF)
Image plane ∞

### [Aspherical Surface Data]

1st surface 5th surface 6th surface 30th surface
K 0.00000 0.00000 0.00000 0.00000
A3 0.00000E+00 −1.65156E−05 −2.04166E−05 0.00000E+00
A4 1.30938E−05 1.53574E−06 −5.39138E−06 −1.78785E−05
A5 0.00000E+00 −1.68596E−05 −1.65584E−05 0.00000E+00
A6 −1.98839E−08 2.19398E−06 2.01360E−06 2.78978E−07
A7 0.00000E+00 −7.59058E−08 −4.09560E−08 0.00000E+00
A8 2.41619E−11 −1.94496E−09 −5.42316E−09 −8.51812E−09
A9 0.00000E+00 8.67238E−11 2.16135E−10 0.00000E+00
A10 −1.82623E−14 5.05299E−12 7.74806E−12 7.90301E−11
A11 0.00000E+00 −5.93823E−14 −4.60896E−13 0.00000E+00
A12 7.84092E−18 −1.38773E−14 −1.86374E−14 −2.84505E−13
A13 0.00000E+00 3.11908E−16 9.51558E−16 0.00000E+00
A14 −1.48833E−21 5.51021E−18 1.13424E−16 1.96430E−16
A15 0.00000E+00 9.06185E−20 −7.86519E−18 0.00000E+00
A16 1.08206E−26 −9.87459E−21 1.18780E−19 6.46300E−19
31st surface
K 0.00000
A3 0.00000E+00
A4 1.60382E−05
A5 0.00000E+00
A6 7.86467E−08
A7 0.00000E+00
A8 −3.28905E−09
A9 0.00000E+00
A10 2.08144E−11
A11 0.00000E+00
A12 4.01215E−14
A13 0.00000E+00
A14 −6.81380E−16
A15 0.00000E+00
A16 1.52268E−18

### [Various Data]

INF 245 mm
Focal length 14.47 13.88
F-number 2.07 2.07
Total angle of view 2ω 114.30 114.11
Image height Y 21.63 21.63
Entire length of lens 128.00 128.00

### [Variable Spacing Data]

INF 245 mm
d0 ∞ 117.0000
d9 9.9046 14.0404
d11 7.6755 3.5397
BF 20.0000 20.0000

### [Lens Group Data]

### Group Start Surface Focal Length

G1 1 −16.90
G2 10 139.44
G3 13 60.46
G4 20 40.88

### Example 4

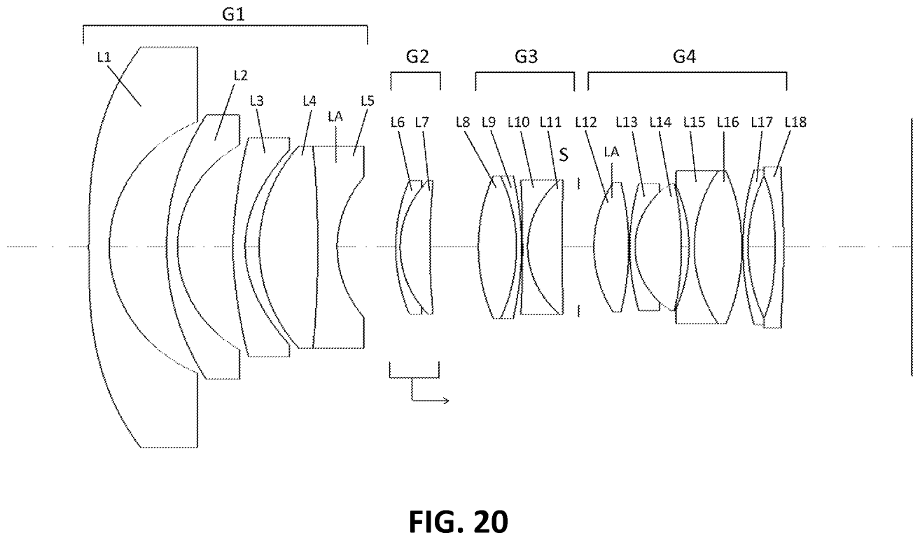

FIG. 20 is a lens configuration diagram of an optical system of the example 4 of the present invention.

The optical system of the example 4 includes, in order from the object side, a first lens group G1 having negative refractive power, a second lens group G2 having positive refractive power, a third lens group G3 having positive refractive power, and a fourth lens group G4 having positive refractive power.

The first lens group G1 corresponds to the object-side lens group GF in claim 1 to claim 6 and corresponds to the lens group GFA that includes the lens LA in claim 7, and a composite group of the second lens group G2 to the fourth lens group G4 corresponds to the image-side lens group GR in claim 1 to claim 6.

A composite group of the first lens group G1 to the third lens group G3 corresponds to the object-side lens group GF in claim 10 to claim 14, the first lens group G1 corresponds to the lens group GFA that includes the lens LA in claim 15, and the fourth lens group G4 corresponds to the image-side lens group GR in claim 10 to claim 14.

An aperture stop S is disposed between the third lens group G3 and the fourth lens group G4.

The first lens group G1 includes, in order from the object side, a negative meniscus lens L1 with the convex surface facing the object side, a negative meniscus lens L2 with the convex surface facing the object side, a negative meniscus lens L3 with the convex surface facing the object side, and a cemented lens that includes a biconvex lens L4 and a biconcave lens L5, and the lens surface of the negative meniscus lens L1 on the object side and the lens surfaces of the negative meniscus lens L3 on both sides have predetermined aspherical shapes. The biconcave lens L5 corresponds to the lens LA in the present invention.

The second lens group G2 includes only a cemented lens that includes a negative meniscus lens L6 with the convex surface facing the object side and a positive meniscus lens L7 with the convex surface facing the object side. In focusing from an infinite object distance to a short distance, the second lens group G2 moves toward the image-side.

The third lens group G3 includes, in order from the object side, a cemented lens that includes a biconvex lens L8 and a negative meniscus lens L9 with the convex surface facing the image side, and a cemented lens that includes a biconcave lens L10 and a positive meniscus lens L11 with the convex surface facing the object side.

The fourth lens group G4 includes, in order from the object side, a biconvex lens L12, a cemented lens that includes a negative meniscus lens L13 with the convex surface facing the object side and a biconvex lens L14, a cemented lens that includes a biconcave lens L15 and a biconvex lens L16, a negative meniscus lens L17 with the convex surface facing the object side, and a negative meniscus lens L18 with the convex surface facing the image-side, and the lens surfaces of the negative meniscus lens L18 on both sides have predetermined aspherical shapes. The biconvex lens L12 corresponds to the lens LA in the present invention.

Specification values of the optical system according to the example 4 are shown below.

### Numerical Example 4

Unit: mm

### [Surface Data]

Surface number r d nd vd θgF
Object surface ∞ (d0)
1* 345.5736 3.2000 1.69350 53.18 0.548185
2 23.2818 8.9032
3 43.3044 1.7000 1.59282 68.62 0.544009
4 20.2688 8.6138
5 46.6429 1.8800 1.59201 67.02 0.535765
6* 18.2799 2.2099
7 26.6989 9.1000 1.85451 25.15 0.610160
8 −193.5728 3.0000 1.42537 97.75 0.534212
9 18.8420 (d9)
10 31.1125 0.7000 2.00069 25.46 0.613492
11 16.8217 4.6143 1.68430 26.81 0.623031
12 121.3655 (d12)
13 32.2912 5.9158 1.91082 35.25 0.582104
14 −30.5864 0.8000 1.92286 20.88 0.638840
15 55.8697 0.1500
16 −252.3463 0.8000 2.00100 29.13 0.599373
17 15.3145 5.3640 1.59349 67.00 0.536541
18 556.5564 2.5846
19 (stop) ∞ 2.3551
20 21.5784 5.4219 1.42537 97.75 0.534212
21 −48.3957 0.1500
22 41.6151 0.8000 1.88300 40.80 0.565434
23 13.0308 7.2226 1.55032 75.50 0.539881
24 −53.9843 1.1910
25 27.1893 0.8000 1.73037 32.23 0.589819
26 24.3547 7.4144 1.92286 20.88 0.638840
27 −34.4511 0.1500
28 49.2619 0.8000 1.85451 25.15 0.610160
29 30.3051 4.2228
30* −61.9600 1.3000 1.69350 53.20 0.546484
31* −140.0670 (BF)
Image plane ∞

### [Aspherical Surface Data]

1st surface 5th surface 6th surface 30th surface
K 0.00000 0.00000 0.00000 0.00000
A3 0.00000E+00 −4.29394E−05 −4.47699E−05 0.00000E+00
A4 1.31973E−05 −3.23917E−06 −1.07631E−05 −1.48304E−05
A5 0.00000E+00 −1.55812E−05 −1.52773E−05 0.00000E+00
A6 −2.12142E−08 2.25385E−06 1.97098E−06 −2.75773E−08
A7 0.00000E+00 −8.26148E−08 −3.01272E−08 0.00000E+00
A8 2.59364E−11 −1.88418E−09 −6.18964E−09 −2.48320E−09
A9 0.00000E+00 8.03602E−11 1.88741E−10 0.00000E+00
A10 −2.02754E−14 4.75377E−12 7.60157E−12 −1.06682E−11
A11 0.00000E+00 −4.51040E−14 −3.91478E−13 0.00000E+00
A12 1.09327E−17 −1.25773E−14 −1.49127E−14 5.33561E−13
A13 0.00000E+00 3.82153E−16 1.10177E−15 0.00000E+00
A14 −4.19867E−21 5.71539E−18 1.14822E−16 −3.53995E−15
A15 0.00000E+00 −1.55740E−19 −8.29782E−18 0.00000E+00
A16 8.60486E−25−8.89043E−21 9.21510E−20 7.21968E−18
31st surface
K 0.00000
A3 0.00000E+00
A4 2.28967E−05
A5 0.00000E+00
A6 −1.93440E−07
A7 0.00000E+00
A8 5.22259E−10
A9 0.00000E+00
A10 −2.27781E−11
A11 0.00000E+00
A12 3.91172E−13
A13 0.00000E+00
A14 −2.16287E−15
A15 0.00000E+00
A16 3.92770E−18

### [Various Data]

INF 230 mm
Focal length 14.00 13.39
F-number 2.07 2.07
Total angle of view 2ω 116.02 115.92
Image height Y 21.63 21.63
Entire length of lens 128.00 128.00

### [Variable Spacing Data]

INF 245 mm
d0 ∞ 102.0000
d9 9.1032 12.8682
d11 7.5336 3.7685
BF 20.0000 20.0000

### [Lens Group Data]

### Group Start Surface Focal Length

G1 1 −16.09
G2 10 121.93
G3 13 67.06
G4 20 38.19

### Example 5

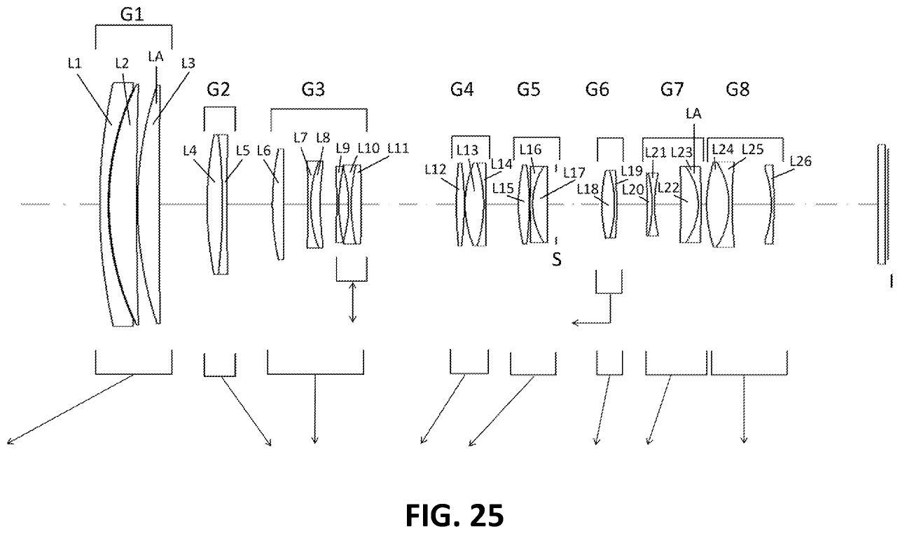

FIG. 25 is a lens configuration diagram of a variable power optical system of the example 5 with focus at infinity at the wide angle end. The example 5 is an example of an optical system where power varies according to the present invention.

The variable power optical system of the example 5 includes, in order from the object side, a first lens group G1 having positive refractive power, a second lens group G2 having positive refractive power, a third lens group G3 having negative refractive power, a fourth lens group G4 having positive refractive power, a fifth lens group G5 having positive refractive power, a sixth lens group G6 having positive refractive power, a seventh lens group G7 having negative refractive power, and an eighth lens group G8 having negative refractive power. An aperture stop S is disposed between the fifth lens group G5 and the sixth lens group G6.

The first lens group G1 corresponds to the object-side lens group GF in claim 18, and a composite group of the second lens group G2 to the eighth lens group G8 corresponds to the image-side lens group GR in claim 18.

A composite group of the first lens group G1 to the fifth lens group G5 corresponds to the object-side lens group GF in claim 25, and a composite group of the sixth lens group G6 to the eighth lens group G8 corresponds to the image-side lens group GR in claim 25.

When power is varied from the wide angle end to the telephoto end, the third lens group G3 and the eighth lens group G8 are fixed with respect to the image plane, the first lens group G1 moves toward the object side, the second lens group G2 moves toward the image side, and the fourth lens group G4 to the seventh lens group G7 move to the object side. Accordingly, a spacing between the first lens group G1 and the second lens group G2 increases, a spacing between the second lens group G2 and the third lens group G3 reduces, a spacing between the third lens group G3 and the fourth lens group G4 reduces, a spacing between the fourth lens group G4 and the fifth lens group G5 reduces, a spacing between the fifth lens group G5 and the sixth lens group G6 increases, a spacing between the sixth lens group and the seventh lens group G7 reduces, and a spacing between the seventh lens group G7 and the eighth lens group G8 increases.

The first lens group G1 includes, in order from the object side, a negative meniscus lens L1 with the convex surface facing the object side, a positive meniscus lens L2 with the convex surface facing the object side, and a positive meniscus lens L3 with the convex surface facing the object side. The positive meniscus lens L3 corresponds to the lens LA in the present invention.

The second lens group G2 includes only a cemented lens that includes a biconvex lens L4 and a biconcave lens L5 in order from the object side.

The third lens group G3 includes, in order from the object side, a biconvex lens L6, a cemented lens that includes a biconcave lens L7 and a positive meniscus lens L8 with the convex surface facing the object side, a biconcave lens L9, and a cemented lens that includes a biconcave lens L10 and a biconvex lens L11. By causing the biconcave lens L9 and the cemented lens that includes the biconcave lens L10 and the biconvex lens L11 of the third lens group G3 to move in the vertical direction with respect to the optical axis as an integral body, it is also possible to cause the biconcave lens L9 and the cemented lens that includes the biconcave lens L10 and the biconvex lens L11 to serve as a vibration-proof group.

The fourth lens group G4 includes, in order from the object side, a biconvex lens L12, and a cemented lens that includes a biconvex lens L13 and a negative meniscus lens L14 with the convex surface facing the image side.

The fifth lens group G5 includes, in order from the object side, a biconvex lens L15, and a cemented lens that includes a negative meniscus lens L16 with the convex surface facing the object side and a biconvex lens L17.

The sixth lens group G6 includes, in order from the object side, only a cemented lens that includes a biconvex lens L18 and a negative meniscus lens L19 with the convex surface facing the image side. In focusing from an infinite object distance to a short distance, the entire sixth lens group G6 moves toward the object side.

The seventh lens group G7 includes, in order from the object side, a cemented lens that includes a positive meniscus lens L20 with the convex surface facing the image side and a biconcave lens L21, and a cemented lens that includes a positive meniscus lens L22 with the convex surface facing the image side and a negative meniscus lens L23 with the convex surface facing the image side. The negative meniscus lens L23 corresponds to the lens LA in the present invention.

The eighth lens group G8 includes, in order from the object side, a cemented lens that includes a biconvex lens L24 and a biconcave lens L25, and a negative meniscus lens L26 with the convex surface facing the image side.

Specification values of the optical system according to the example 5 are shown below.

### Numerical Example 5

Unit: mm

### [Surface Data]

Surface number r d nd vd θgF
Object surface ∞ (d0)
1 229.5367 2.9999 1.61340 44.27 0.563261
2 113.6783 0.3042
3 113.6776 9.7491 1.49700 81.61 0.538747
4 1554.0767 0.4000
5 155.4355 7.6390 1.41390 100.82 0.533605
6 2378.2886 (d6)
7 149.1765 5.4165 1.80518 25.46 0.615570
8 −243.4151 1.4497 1.92286 20.88 0.638840
9 615.6485 (d9)
10 103.0359 3.9954 1.53172 48.84 0.562956
11 −2868.5651 8.6239
12 −576.2228 1.0000 1.95375 32.32 0.590421
13 49.3785 3.3171 1.80809 22.76 0.628525
14 110.3663 5.8425
15 1447.6315 0.8985 1.78590 44.20 0.563036
16 69.9168 3.4207
17 −53.3084 0.8976 1.76385 48.49 0.558845
18 70.2262 3.5785 1.85451 25.15 0.610160
19 −508.3408 (d19)
20 173.4815 2.8197 1.76385 48.49 0.558845
21 −121.8628 0.3000
22 44.0638 6.5847 1.41390 100.82 0.533605
23 −53.5108 0.8996 1.91082 35.25 0.582104
24 −566.9645 (d24)
25 69.1711 3.8855 1.72825 28.32 0.607404
26 −115.6877 0.3000
27 434.2774 0.8997
28 29.0131 5.2716 1.91082 35.25 0.582104
29 −794.7897 3.0000 1.41390 100.82 0.533605
30 (stop) ∞ (d30)
31 60.0072 4.5217 1.74077 27.76 0.607621
32 −49.5858 0.8000 1.94595 17.98 0.654432
33 −186.1592 (d33)
34 −250.7606 1.7524 1.82166 24.04 0.623642
58.2923 0.8998 1.90525 35.04 0.584723
36 52.8406 9.4298
37 −281.2955 6.0996 1.61340 44.27 0.563261
38 −25.9751 0.9999 1.41390 100.82 0.533605
39 −305.6963 (d39)
40 55.5004 7.9523 1.61340 44.27 0.563261
41 −32.0309 0.9998 1.53775 74.70 0.539232
42 148.3945 13.9898
43 −42.9000 0.8999 1.95375 32.32 0.590421
44 −258.7263 37.0956
45 ∞ 2.5000 1.51680 64.20 0.534177
46 ∞ (BF)
Image plane ∞

### [Various Data]

Zoom ratio 3.74
Wide angle intermediate telephoto
Focal length 154.50 280.00 577.80
F-number 5.16 5.80 6.49
Total angle of view 2ω 15.68 8.65 4.18
Image height Y 21.63 21.63 21.63
Entire length of lens 280.00 333.16 380.00

### [Variable Spacing Data]

### Wide Angle Intermediate Telephoto

d0 00 00 00
d6 17.0583 74.2825 131.3315
d9 16.2732 12.2077 2.0000
d19 33.7924 21.0378 2.0000
d24 11.4042 4.8495 2.1386
d30 16.2626 26.5499 44.8691
d33 10.7755 9.2044 3.3000
d39 2.0000 12.5930 21.9269
BF 1.0000 1.0000 1.0000

### [Lens Group Data]

### Group Start Surface Focal Length

G1 1 263.4314
G2 7 289.6265
G3 10 −34.6015
G4 20 76.7664
G5 25 367.2863
G6 31 75.5253
G7 34 −78.2659
G8 40 −203.8433

### Example 6

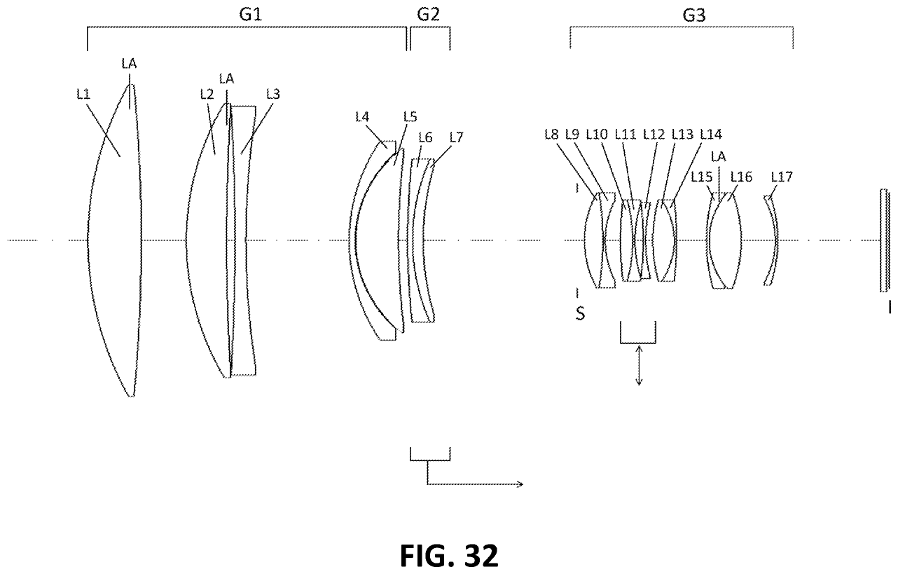

FIG. 32 is a lens configuration diagram of an optical system of the example 6 with focus at infinity. The example 6 is an example of an optical system where no power varies according to the present invention.

The optical system of the example 6 includes, in order from the object side, a first lens group G1 having positive refractive power, a second lens group G2 having negative refractive power, and a third lens group G3 having negative refractive power. An aperture stop S is disposed between the second lens group G2 and the third lens group G3.

A composite group of the first lens group G1 and the second lens group G2 corresponds to the object-side lens group GF in claim 18 and claim 25, and the third lens group G3 corresponds to the image-side lens group GR in claim 18 and claim 25.

The first lens group G1 includes, in order from the object side, a biconvex lens L1, a positive meniscus lens L2 with the convex surface facing the object side, a biconcave lens L3, and a cemented lens that includes a negative meniscus lens L4 with the convex surface facing the object side and a positive meniscus lens L5 with the convex surface facing the object side. Each of the biconvex lens L1 and the positive meniscus lens L2 corresponds to the lens LA in the present invention.

The second lens group G2 includes only a cemented lens that includes a negative meniscus lens L6 with the convex surface facing the object side and a positive meniscus lens L7 with the convex surface facing the object side. In focusing from an infinite object distance to a short distance, the entire second lens group G2 moves toward the image-side.

The third lens group G3 includes a cemented lens that includes a biconvex lens L8 and a biconcave lens L9, a cemented lens that includes a biconvex lens L10 and a biconcave lens L11, a biconcave lens L12, a cemented lens that includes a biconvex lens L13 and a negative meniscus lens L14 with the convex surface facing the image-side, a cemented lens that includes a negative meniscus lens L15 with the convex surface facing the object side and a biconvex lens L16, and a negative meniscus lens L17 with the convex surface facing the image-side. The negative meniscus lens L15 corresponds to the lens LA in the present invention. By causing the cemented lens that includes the biconvex lens L10 and the biconcave lens L11, and the biconcave lens L12 of the third lens group G3 to move in the vertical direction with respect to the optical axis as an integral body, it is also possible to cause the cemented lens that includes the biconvex lens L10 and the biconcave lens L11, and the biconcave lens L12 to serve as a vibration-proof group.

Specification values of the optical system according to the example 6 are shown below.

### Numerical Example 6

Unit: mm

### [Surface Data]

Surface number r d nd vd θgF
Object surface ∞ (d0)
1 153.4863 22.0000 1.42537 97.75 0.534212
2 −789.8781 18.5397
3 128.1087 16.6088 1.41390 100.82 0.533605
4 1068.1574 3.4364
5 −1078.9331 4.5000 1.65160 58.54 0.538879
6 402.3975 42.5469
7 84.3943 2.5000 1.88300 40.80 0.565434
8 54.8662 0.1500
9 54.2574 17.6556 1.43700 95.10 0.533516
10 341.7838 (d10)
11 379.2478 2.0000 1.88100 40.14 0.569968
12 96.1649 4.3878 1.92286 20.88 0.638840
13 125.4389 (d13)
14 (stop) ∞ 3.0000
15 47.1304 7.6236 1.95375 32.32 0.590421
16 −136.1010 0.9500 1.84666 23.78 0.619078
17 42.9084 6.2385
18 152.3712 5.0488 1.85451 25.15 0.610160
19 −73.8150 0.9500 1.76385 48.49 0.558845
20 58.7382 3.4228
21 −138.9520 0.9500 1.69680 55.46 0.542469
22 70.9139 3.0000
23 74.4387 8.7925 1.68893 31.16 0.598858
24 −34.5131 0.9500 1.95375 32.32 0.590421
25 −181.5318 12.3412
26 85.6865 1.1000 1.41390 100.82 0.533605
27 34.6404 13.2138 1.48749 70.44 0.530491
28 −64.2408 14.0691
29 −40.8218 1.0001 1.95375 32.32 0.590421
30 −66.9955 42.4101
31 ∞ 2.4000 1.51680 64.17 0.534826
32 ∞ (BF)
Image plane ∞

### [Various Data]

INF 2675 mm
Focal length 388.00 287.57
F-number 2.88 2.92
Total angle of view 2ω 6.32 4.62
Image height Y 21.63 21.63
Entire length of lens 330.00 330.00

### [Variable Spacing Data]

INF 2675 mm
d0 ∞ 2345.0001
d10 3.7975 31.5887
d13 63.4170 35.6257
BF 1.0000 1.0000

### [Lens Group Data]

### Group Start Surface Focal Length

G1 1 199.08
G2 11 −220.49
G3 14 −470.94

### Example 7

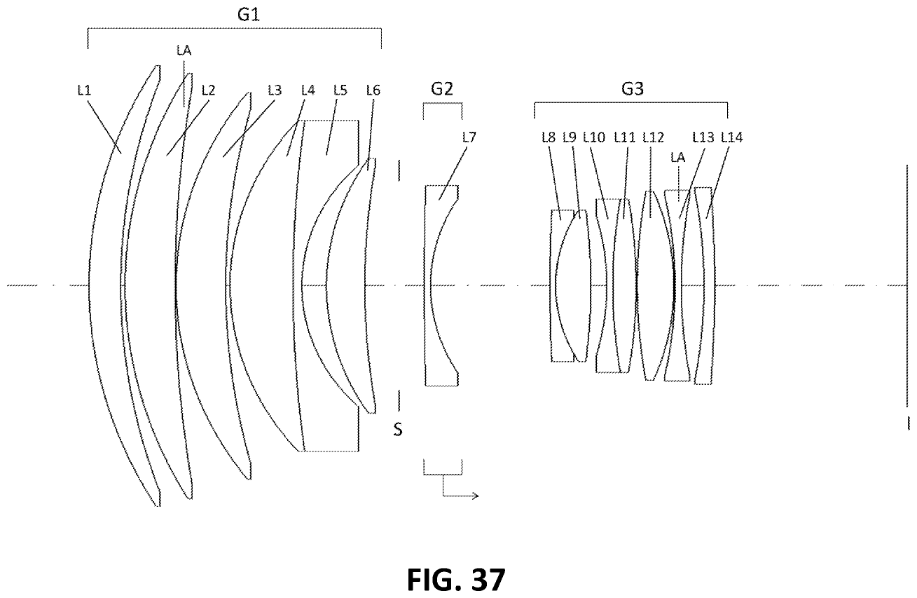

FIG. 37 is a lens configuration diagram of an optical system of the example 7 with focus at infinity. The example 7 is an example of an optical system where no power varies according to the present invention.

The optical system of the example 7 includes, in order from the object side, a first lens group G1 having positive refractive power, a second lens group G2 having negative refractive power, and a third lens group G3 having positive refractive power. An aperture stop S is disposed between the first lens group G1 and the second lens group G2.

A composite group of the first lens group G1 and the second lens group G2 corresponds to the object-side lens group GF in claim 18, and the third lens group G3 corresponds to the image-side lens group GR in claim 18.

The first lens group G1 corresponds to the object-side lens group GF in claim 25, and a composite group of the second lens group G2 and the third lens group G3 corresponds to the image-side lens group GR in claim 25.

The first lens group G1 includes, in order from the object side, a positive meniscus lens L1 with the convex surface facing the object side, a positive meniscus lens L2 with the convex surface facing the object side, a positive meniscus lens L3 with the convex surface facing the object side, a cemented lens that includes a positive meniscus lens L4 with the convex surface facing the object side and a negative meniscus lens L5 with the convex surface facing the object side, and a positive meniscus lens L6 with the convex surface facing the object side. The positive meniscus lens L2 corresponds to the lens LA in the present invention.

The second lens group G2 includes only a negative meniscus lens L7 with the convex surface facing the object side. In focusing from an infinite object distance to a short distance, the entire second lens group G2 moves toward the image-side.

The third lens group G3 includes a cemented lens that includes a negative meniscus lens L8 with the convex surface facing the object side and a biconvex lens L9, a cemented lens that includes a biconcave lens L10 and a biconvex lens L11, a biconvex lens L12, a biconcave lens L13, and a negative meniscus lens L14 with the convex surface facing the image-side, and the lens surfaces of the negative meniscus lens L14 on both sides have predetermined aspherical shapes, the convex surface of the negative meniscus lens L14 facing the image-side. The biconcave lens L13 corresponds to the lens LA in the present invention.

Specification values of the optical system according to the example 7 are shown below.

### Numerical Example 7

Unit: mm

### [Surface Data]

Surface number r d nd vd θgF
Object surface ∞ (d0)
1 72.6808 5.0242 1.94595 17.98 0.654432
2 104.0955 0.7000
3 72.1022 7.9180 1.41390 100.82 0.533605
4 217.7112 0.1500
5 54.3986 7.8515 1.59282 68.62 0.544009
6 118.8800 0.7000
7 42.8489 9.9642 1.55032 75.50 0.539881
8 218.4736 1.4000 1.85478 24.80 0.612166
9 28.4179 3.9004
10 39.3462 6.0649 1.59282 68.62 0.544009
11 127.4290 5.4355
12 (stop) ∞ (d12)
13 657.7179 1.0000 1.51742 52.15 0.558829
14 28.1131 (d14)
15 287.8934 0.9000 1.85451 25.15 0.610160
16 25.1931 5.5789 1.59282 68.62 0.544009
17 −106.2671 2.5244
18 −44.0902 0.9500 1.55032 75.50 0.539881
19 92.5544 3.7150 1.68430 26.81 0.623031
20 89.6313 0.1500
21 96.6146.5.8235 1.78880 28.43 0.600773
22 −42.0630 0.1500
23 −75.0235 1.0000 1.41390 100.82 0.533605
24 89.0720 3.6009
25 90.9091 1.7000 1.51633 64.06 0.533322
26* −200.0000 (BF)
Image plane ∞

### [Aspherical Surface Data]

25th surface 26th surface
K 0.00000 0.00000
A4 2.23113E−06 3.95648E−06
A6 −2.52151E−08 −2.40968E−08
A8 9.33417E−11 6.86747E−11
A10 −1.19404E−13 −5.63942E−14
A12 3.13559E−17 −3.57179E−17
A14 0.00000E+00 0.00000E+00

### [Various Data]

INF 800 mm
Focal length 131.00 111.39
F-number 1.85 2.10
Total angle of view 2w 18.04 15.44
Image height Y 21.63 21.63
Entire length of lens 129.50 129.50

### [Variable Spacing Data]

INF 800 mm
d0 ∞ 670.5000
d12 3.9792 17.1120
d14 18.8972 5.7644
BF 30.4221 30.4221

### [Lens Group Data]

### Group Start Surface Focal Length

G1 1 78.79
G2 13 −56.79
G3 15 101.15

Values corresponding to the conditional expressions of the respective examples are shown below. [Values corresponding to conditional expressions] Conditional expression example 1 example 2 example 3 example 4

VD_A>96.00100.82100.82100.8297.75 (1)

ΔθgF_A>0.057 0.067 0.067 0.067 0.062 (2)

### Conditional Expression Example 5 Example 6 Example 7

VD_A>96.00100.82100.82100.8297.75 (1)

ΔθgF_A>0.057 0.067 0.067 0.067 0.062 (2)

DAF/f>0.2700.3460.372 to0.4630.271 (3)

DAR/f>0.1200.1240.1370.333 (4)

0.40>DFR/LT>0.100.34560.19220.1459 (5)

0.70>HS/HR1>0.200.28310.31580.5084 (6)

### REFERENCE SIGNS LIST

S: aperture stop
I: image plane
G1: first lens group
G2: second lens group
G3: third lens group
G4: fourth lens group
G5: fifth lens group
G6: sixth lens group
G7: seventh lens group
G8: eighth lens group
GF: object-side lens group
GR: image-side lens group
C C line (wavelength λ=656.3 nm)
d d line (wavelength λ=587.6 nm)
g g line (wavelength λ=435.8 nm)
Y image height
ΔS sagittal image plane
ΔM meridional image plane

What is claimed is:

1. An optical system, wherein
an object-side lens group GF and an image-side lens group GR are arranged in order from an object side, the object-side lens group GF has negative refractive power as a whole, and the image-side lens group GR has positive refractive power as a whole, and
at least either one of the object-side lens group GF or the image-side lens group GR includes a lens LA that satisfies a following conditional expression (1):
VD_A>96.00 (1)
where
VD_A: an Abbe number of the lens LA based on a d line.

2. The optical system according to claim 1, wherein
the lens LA satisfies a following conditional expression (2):
ΔθgF_A>0.057 (2)
where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by
ΔθgF=θgF−(0.648285−0.00180123×VD)
in a case where the partial dispersion ratio with respect to the g line is taken as θgF, and an Abbe number for the d line is taken as VD.

3. The optical system according to claim 1, wherein
in a case where power of the optical system varies, at least a spacing between the object-side lens group GF and the image-side lens group GR changes when the power varies, and
the lens LA is disposed in the object-side lens group GF and has negative refractive power.

4. The optical system according to claim 1, wherein
in a case where power of the optical system varies, at least a spacing between the object-side lens group GF and the image-side lens group GR changes when the power varies, and
the lens LA is disposed in the image-side lens group GR and has positive refractive power.

5. The optical system according to claim 1, wherein
with focus being at infinity in a maximum wide angle state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR, and
the lens LA is disposed in the object-side lens group GF and has negative refractive power.

6. The optical system according to claim 1, wherein
with focus being at infinity in a maximum wide angle state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR, and
the lens LA is disposed in the image-side lens group GR and has positive refractive power.

7. The optical system according to claim 1, wherein
the optical system includes a lens group GFA that includes the lens LA and that has negative refractive power,
in a case where power of the optical system varies, in dividing the object-side lens group GF into lens groups by using, as boundaries, all air spacings that change when the power varies, the lens group GFA is disposed at a position closest to an image-side in the object-side lens group GF, or the lens group GFA is identical with the object-side lens group GF,
in a case where no power of the optical system varies, the lens group GFA is identical with the object-side lens group GF, and
the lens group GFA includes four or more lenses.

8. The optical system according to claim 1, wherein
the object-side lens group GF has an aspherical surface where positive refractive power increases or negative refractive power decreases with respect to a center of an optical axis in an area around an effective light diameter.

9. The optical system according to claim 1, wherein
the image-side lens group GR has an aspherical surface where positive refractive power decreases or negative refractive power increases with respect to a center of an optical axis in an area around an effective light diameter.

10. An optical system, wherein
an object-side lens group GF and an image-side lens group GR are arranged in order from an object side, an aperture stop is disposed between the object-side lens group GF and the image-side lens group GR, the object-side lens group GF has positive refractive power or negative refractive power as a whole, and the image-side lens group GR has positive refractive power as a whole, and
at least either one of the object-side lens group GF or the image-side lens group GR includes a lens LA that satisfies a following conditional expression (1):
VD_A>96.00 (1)
where
VD_A: an Abbe number of the lens LA based on a d line.

11. The optical system according to claim 10, wherein
the lens LA satisfies a following conditional expression (2):
ΔθgF_A>0.057 (2)
where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by
ΔθgF=θgF−(0.648285−0.00180123×VD)
in a case where the partial dispersion ratio with respect to the g line is taken as θgF, and an Abbe number for the d line is taken as VD.

12. The optical system according to claim 10, wherein
in a case where power of the optical system varies, at least a spacing between the object-side lens group GF and the image-side lens group GR changes when the power varies, and
the lens LA is disposed in the object-side lens group GF and has negative refractive power.

13. The optical system according to claim 10, wherein
in a case where power of the optical system varies, at least a spacing between the object-side lens group GF and the image-side lens group GR changes when the power varies, and
the lens LA is disposed in the image-side lens group GR and has positive refractive power.

14. The optical system according to claim 10, wherein
with focus being at infinity in a maximum wide angle state in a case where power of the optical system varies, or with focus being at infinity in a case where no power of the optical system varies, a height, from an optical axis, of an axial marginal ray that passes through the aperture stop is greater than a height, from the optical axis, of an axial marginal ray that passes through an optical surface of the optical system that is disposed at a position closest to the object side.

15. The optical system according to claim 10, wherein
the optical system includes a lens group GFA that includes the lens LA and that has negative refractive power,
in a case where power of the optical system varies, in dividing the object-side lens group GF into lens groups by using, as boundaries, all air spacings that change when the power varies, the lens group GFA is disposed at a position closest to the object side among lens groups included by the object-side lens group GF and having negative refractive power,
in a case where no power of the optical system varies, in dividing the object-side lens group GF into lens groups by using, as boundaries, all air spacings that change when focusing is performed, the lens group GFA is disposed at a position closest to the object side among lens groups included by the object-side lens group GF and having negative refractive power, and
the lens group GFA includes four or more lenses.

16. The optical system according to claim 10, wherein
the object-side lens group GF has an aspherical surface where positive refractive power increases or negative refractive power decreases with respect to a center of the optical axis in an area around an effective light diameter.

17. The optical system according to claim 10, wherein
the image-side lens group GR has an aspherical surface where positive refractive power decreases or negative refractive power increases with respect to a center of the optical axis in an area around an effective light diameter.

18. An optical system, wherein
an object-side lens group GF having positive refractive power and an image-side lens group GR are arranged in order from an object side, an aperture stop is provided, and the optical system includes a lens LA that satisfies a following conditional expression (1):
VD_A>96.00 (1)
where
VD_A: an Abbe number of the lens LA based on a d line.

19. The optical system according to claim 18, wherein
the lens LA satisfies a following conditional expression (2):
ΔθgF_A>0.057 (2)
where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by
ΔθgF=θgF−(0.648285−0.00180123×VD)
in a case where the partial dispersion ratio with respect to the g line is taken as θgF, and an Abbe number for the d line is taken as VD.

20. The optical system according to claim 18, wherein
in a case where power of the optical system varies, at least a spacing between the object-side lens group GF and the image-side lens group GR changes when the power varies,
the lens LA is disposed in the object-side lens group GF and has positive refractive power, and
a following conditional expression (3) is satisfied:
DAF/f>0.270 (3)
where
in a case where no power of the optical system varies,
DAF: a spacing on an optical axis between an image-side surface of the lens LA disposed in the object-side lens group GF and the aperture stop with focus at infinity
f: a focal length of the optical system with focus at infinity
in the case where the power of the optical system varies,
DAF: a spacing on the optical axis between the image-side surface of the lens LA disposed in the object-side lens group GF and the aperture stop with focus at infinity in a maximum telephoto state
f: a focal length of the optical system with focus at infinity in the maximum telephoto state.

21. The optical system according to claim 18, wherein
in a case where power of the optical system varies, at least a spacing between the object-side lens group GF and the image-side lens group GR changes when the power varies,
the lens LA is disposed in the image-side lens group GR and has negative refractive power, and
a following conditional expression (4) is satisfied:
DAR/f>0.120 (4)
where
in a case where no power of the optical system varies,
DAR: a spacing on an optical axis between the aperture stop and an object-side surface of the lens LA disposed in the image-side lens group GR with focus at infinity
f: a focal length of the optical system with focus at infinity
in the case where the power of the optical system varies,
DAR: a spacing on the optical axis between the aperture stop and the object-side surface of the lens LA disposed in the image-side lens group GR with focus at infinity in a maximum telephoto state
f: a focal length of the optical system with focus at infinity in the maximum telephoto state.

22. The optical system according to claim 18, wherein
with focus being at infinity in a maximum telephoto state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR,
the lens LA is disposed in the object-side lens group GF and has positive refractive power, and
a following conditional expression (3) is satisfied:
DAF/f>0.270 (3)
where
in the case where no power of the optical system varies,
DAF: a spacing on an optical axis between an image-side surface of the lens LA disposed in the object-side lens group GF and the aperture stop with focus at infinity
f: a focal length of the optical system with focus at infinity
in the case where the power of the optical system varies,
DAF: a spacing on the optical axis between the image-side surface of the lens LA disposed in the object-side lens group GF and the aperture stop with focus at infinity in the maximum telephoto state
f: a focal length of the optical system with focus at infinity in the maximum telephoto state.

23. The optical system according to claim 18, wherein
with focus being at infinity in a maximum telephoto state in a case where power of the optical system varies, or with focus being at infinity in a case where no power of the optical system varies, a largest spacing of air spacings each formed between lenses of the optical system that are adjacent to each other is a spacing between the object-side lens group GF and the image-side lens group GR,
the lens LA is disposed in the image-side lens group GR and has negative refractive power, and
a following conditional expression (4) is satisfied:
DAR/f>0.120 (4)
where
in the case where no power of the optical system varies,
DAR: a spacing on an optical axis between the aperture stop and an object-side surface of the lens LA disposed in the image-side lens group GR with focus at infinity
f: a focal length of the optical system with focus at infinity
in the case where the power of the optical system varies,
DAR: a spacing on the optical axis between the aperture stop and the object-side surface of the lens LA disposed in the image-side lens group GR with focus at infinity in the maximum telephoto state
f: a focal length of the optical system with focus at infinity in the maximum telephoto state.

24. The optical system according to claim 22, wherein
a following conditional expression (5) is satisfied:
0.40>DFR/LT>0.10 (5)
where
in the case where no power of the optical system varies,
DFR: an air spacing on the optical axis between the object-side lens group GF and the image-side lens group GR with focus at infinity
LT: a spacing on the optical axis between a surface of the optical system that is disposed at a position closest to the object side and an image plane with focus at infinity
in the case where the power of the optical system varies,
DFR: an air spacing on the optical axis between the object-side lens group GF and the image-side lens group GR with focus at infinity in the maximum telephoto state
LT: a spacing on the optical axis between the surface of the optical system that is disposed at the position closest to the object side and the image plane with focus at infinity in the maximum telephoto state.

25. An optical system, wherein
an object-side lens group GF having positive refractive power and an image-side lens group GR are arranged in order from an object side, an aperture stop is disposed between the object-side lens group GF and the image-side lens group GR, and the optical system includes a lens LA that satisfies a following conditional expression (1):
VD_A>96.00 (1)
where
VD_A: an Abbe number of the lens LA based on a d line.

26. The optical system according to claim 25, wherein
the lens LA satisfies a following conditional expression (2):
ΔθgF_A>0.057 (2)
where
ΔθgF_A: a mean value of a deviation ΔθgF of a partial dispersion ratio of the lens LA with respect to a g line,
wherein the deviation ΔθgF of the partial dispersion ratio with respect to the g line is calculated for each lens by
ΔθgF=θgF−(0.648285−0.00180123×VD)
in a case where the partial dispersion ratio with respect to the g line is taken as θgF, and an Abbe number for the d line is taken as VD.

27. The optical system according to claim 25, wherein
the lens LA is disposed in the object-side lens group GF and has positive refractive power, and
a following conditional expression (3) is satisfied:
DAF/f>0.270 (3)
where
in a case where no power of the optical system varies,
DAF: a spacing on an optical axis between an image-side surface of the lens LA disposed in the object-side lens group GF and the aperture stop with focus at infinity
f: a focal length of the optical system with focus at infinity
in a case where power of the optical system varies,
DAF: a spacing on the optical axis between the image-side surface of the lens LA disposed in the object-side lens group GF and the aperture stop with focus at infinity in a maximum telephoto state
f: a focal length of the optical system with focus at infinity in the maximum telephoto state.

28. The optical system according to claim 25, wherein
the lens LA is disposed in the image-side lens group GR and has negative refractive power, and
a following conditional expression (4) is satisfied:
DAR/f>0.120 (4)
where
in a case where no power of the optical system varies,
DAR: a spacing on an optical axis between the aperture stop and an object-side surface of the lens LA disposed in the image-side lens group GR with focus at infinity
f: a focal length of the optical system with focus at infinity
in a case where power of the optical system varies,
DAR: a spacing on the optical axis between the aperture stop and the object-side surface of the lens LA disposed in the image-side lens group GR with focus at infinity in a maximum telephoto state
f: a focal length of the optical system with focus at infinity in the maximum telephoto state.

29. The optical system according to claim 25, wherein
in the case where the power of the optical system varies, with focus at infinity in the maximum telephoto state, or in the case where no power of the optical system varies, with focus at infinity, a height, from the optical axis, of an axial marginal ray that passes through the aperture stop is less than a height, from the optical axis, of an axial marginal ray that passes through an optical surface of the optical system that is disposed at a position closest to the object side.

30. The optical system according to claim 29, wherein
a following conditional expression (6) is satisfied:
0.70>HS/HR1>0.20 (6)
where
in the case where no power of the optical system varies,
HS: the height, from the optical axis, of the axial marginal ray that passes through the aperture stop with focus at infinity
HR1: the height, from the optical axis, of the axial marginal ray that passes through the optical surface of the optical system that is disposed at the position closest to the object side with focus at infinity
in the case where the power of the optical system varies,
HS: the height, from the optical axis, of the axial marginal ray that passes through the aperture stop with focus at infinity in the maximum telephoto state
HR1: the height, from the optical axis, of the axial marginal ray that passes through the optical surface of the optical system that is disposed at the position closest to the object side with focus at infinity in the maximum telephoto state.

31. The optical system according to claim 23, wherein a following conditional expression (5) is satisfied:
0.40>DFR/LT>0.10 (5)
where
in the case where no power of the optical system varies,
DFR: an air spacing on the optical axis between the object-side lens group GF and the image-side lens group GR with focus at infinity
LT: a spacing on the optical axis between a surface of the optical system that is disposed at a position closest to the object side and an image plane with focus at infinity
in the case where the power of the optical system varies,
DFR: an air spacing on the optical axis between the object-side lens group GF and the image-side lens group GR with focus at infinity in the maximum telephoto state
LT: a spacing on the optical axis between the surface of the optical system that is disposed at the position closest to the object side and the image plane with focus at infinity in the maximum telephoto state.
